(19) United States
(12) Patent Application Publication
(10) Pub. No.: US 2012/0015177 A1
(43) Pub. Date: Jan. 19, 2012

(54) MATRIX CONTAINING NEPHRITE JADE POWDER AS MAIN COMPONENT AND PREPARATION METHOD THEREOF

(76) Inventor: Dong Wook KIM, Seoul (KR)

(21) Appl. No.: 12/836,866

(22) Filed: Jul. 15, 2010

(51) Int. Cl. B32B 5/16; B29C 39/38

(52) U.S. Cl. 428/328; 264/319

(57) ABSTRACT

Disclosed here are a matrix containing nephrite jade powder as a main component and a preparation method thereof. The matrix comprises, based on the total weight of a raw material for making a molded article, 1-4 wt % of nephrite jade powder having a particle size of 360-1000 mesh, and 0.5-1 wt % of bentonite or zeolite. The matrix improves the physical and mechanical strength of articles formed therefrom and can also be used as a functional material that gives beneficial effects to the human body.

### BACKGROUND OF THE INVENTION

(a) Field of the Invention

The present invention relates to a matrix containing nephrite jade powder as a main component and a preparation method thereof, and more particularly to a matrix prepared by adding (1) fine powder of nephrite jade comprising fibers of the tremolite-actinolite series, which have a microscopic interwoven fiber structure, and (2) bentonite or zeolite to a raw material (synthetic resin).

(b) Background of the Related Art

As is generally known, jade is largely divided into jadeite and nephrite jade. Jadeite belongs to pyroxene family and has monoclinic system comprising silicic acid, aluminum oxide and soda. It is an intimate mass, and the hardness is comparable to that of crystal. It is transparent or translucent of black, blue green or green color. People usually say the jadeite as “jade”.

Nephrite jade is a pyribole mineral having monoclinic system of inosilicates and classified into nephrite jade in dolomitic marble and into serpentine ultra-basic nephrite jade. The quality thereof is determined by the fine structure, that is, the coarse and fine degree to which tremolite-actinolite crystals are formed into aggregates and fibers. It is known that the finer the fiber, the better is the quality.

According to a German literature [Mauda Palmer Die Verborgene, “KRAFF der KRISTALLE and der EDELSTEINE”], the two different ores, jadeite and nephrite jade, both comprise silicon and oxygen, as most of other jewels. However, jadeite is formed of granular crystals while nephrite jade consists of lots of crystals and aggregates of microparticles having fibrous, hair-like structure. In particular, nephrite jade comprises three elements, Ca, Fe and Mg, which are good for human body, while jadeite comprises sodium and aluminum components. Thus, it has been recently reported that nephrite jade, when attached to the body, provides a considerable effect to the treatment of hypertension, diabetes, circulating system disorder, heart disease and kidney disorder. This fact is also disclosed in “Die Magie der Edelsteine” published by Hedy Brusisu of Germany.

A classic of traditional oriental medicine, “Treasures in oriental medicine” describes that if jade is added to black rice liquor to alter the liquor to water, and intake of jade powder in a size like sesame seed is good for the discharge of the waste material. Also it describes that when jade powder (1 part by volume), rice (1 part by volume) and white dew (1 part by volume) are cooked to rice in a copper vessel, the jade powder becomes water (so called jade-liquid, the “divine jade water”). “Plants of Divine Agriculture”, “Plants of Tang Age” and “List of Basic Plants” describes that intake of jade powder in a size like sesame seed enriches five viscera and six entrails and completely discharges the waste materials. In addition, it is effective to digestive system by remove heat from stomach, and it is good for the treatment of bronchus asthma, body fever and heavy feeling in the chest as well as thirst. When jade powder is taken for a long time, body becomes easy and light, function of lung is enhanced, making voice by vocal cords becomes easier. Also, it is good for throat, nutrition of hair, functions of five viscera and six entrails and treatment of nervous diseases such as stress. Besides, it has been known that the components of nephrite jade reveal excellent functions to the body without side effect. For example, intake of white jade powder is good for the tension or cramps in the muscles and rubbing with nephrite jade on the hurted skin for several days removes the scar.

However, as nephrite jade collected from Chuncheon, South Korea among nephrite jades does not exists in a large amount in the nature, the use thereof is restricted to jewel personal ornaments such as necklace, ring, bracelet, or the like in spite of the well known excellent medical functions due to its scarcity. In addition, the processing of nephrite jade requires much time and effort, and delicate attention of experts having much experience. Further, nephrite jade is economically disadvantageous as being a very high-priced product, and thus the development as a general practical goods using nephrite jade has not been made at all. Therefore, there is an urgent need for research and development of nephrite jade.

Meanwhile, in the production of molded synthetic resin products, bioceramic material, elvan or the like is added, but products having excellent effects in terms of strength or others aspects are not obtained due to the properties of the mineral.

Relevant publications in the field include U.S. Pat. No. 5,879,797 (referred to herein as “Patent Document 1”) and non-patent literature document Kim, Won-Sa, “Nephrite from Chuncheon, Korea”, J. Gemmol., 1995 (referred to herein as “Non-Patent Document 1”).

### SUMMARY OF THE INVENTION

On the basis of the fact that nephrite jade provides beneficial effects as described above, the present inventor has conducted studies and experiments over a long period of time, thereby completing the present invention.

It is an object of the present invention to provide a matrix prepared by adding (1) a specific amount of fine powder of nephrite jade comprising fibers of the tremolite-actinolite series, which have a microscopic interwoven fiber structure, and (2) a specific amount of bentonite or zeolite to a synthetic resin raw material, and compounding the mixture, and a preparation method thereof, wherein the matrix can be used to manufacture various goods, including medical goods, packaging goods, vessels, interior goods, industrial goods, traffic goods, transportation goods, utensil goods, goods for sports, agricultural and fishery goods, electronic instruments, precision instruments and the like, which have improved strength, and, in addition, wherein useful wavelengths which are emitted from the active ingredients contained in the goods can exhibit excellent effects of treating human diseases (headache, insomnia, indigestion, numbness, etc.), removing impurities (such as heavy metals), improving the quality of water and promoting the growth of animals and plants.

To achieve the above object, in one aspect, the present invention provides a matrix containing nephrite jade powder as a main component, wherein the matrix comprises, based on the total weight of a synthetic resin raw material, 1-4.5 wt % of nephrite powder having a particle size of 360-1,000 mesh, and 0.5-1 wt % of bentonite or zeolite.

In another aspect, the present invention provides a method for preparing a matrix containing nephrite powder as a main component, the method comprising the steps of: adding to a synthetic resin raw material 1-4.5 wt % of nephrite powder having a particle size of 360-1,000 meshes and 0.5-1 wt % of bentonite or zeolite to obtain a mixture; heating the mixture at a temperature between 135° C. and 145° C.; and molding the heated mixture to obtain a compound.

The nephrite jade that is used in the present invention is preferably a tremolite nephrite jade in dolomitic marble, which has a negative value of δ ¹⁸0 and comprises the following compounds:

Semi-quantitative analysis of nephrite jade
powder used in the present invention (%)

| | | | |
|---|---|---|---|
| Silicon | 34 | Tin | 0.024 |
| Magnesium | 10 | Beryllium | 0.00072 |
| Calcium | 4.9 | Silver | 0.0013 |
| Iron | 0.23 | Titanium | 0.0038 |
| Aluminum | 0.16 | Nickel | 0.0028 |
| Copper | 0.17 | Chromium | 0.0030 |
| Cobalt | 0.046 | Other elements | 0 |
| Manganese | 0.14 | | |

The particle size of the nephrite jade powder used in the preparation of the matrix according to the present invention is generally selected by considering the material of the molded article. Preferably, nephrite jade powder having the particle size of 100-360 mesh is used. However, if increased ductility is required, for example, in the case of a vinyl sheet or laminated paper having a small thickness, nephrite jade powder having a smaller particle size of about 360-1000 mesh is more preferably used.

If the particle size of nephrite jade powder and bentonite or zeolite, which are added to the synthetic resin, is higher than the above-specified range, it is disadvantageous because the surface roughness of the article becomes larger, and if the particle size is lower than the above-specified range, difficulties occur in the grinding process, thus increasing the economic burden.

If the amount of nephrite jade powder added to the synthetic resin is less than 1%, the effect of nephrite jade powder cannot be expected. As the amount of nephrite jade powder added is increased, the inherent effect of nephrite jade is improved, but if the amount is excessively large, the properties of the raw material resin (in particular, ductility) is lowered to make the article brittle, and the cost of the product is also increased owing to the high price of nephrite jade. Thus, the amount of nephrite jade is preferably 4.5% by weight or less based on the total weight of the raw material resin.

Also, in the sample, bentonite is added as an additive for improving the mineral characteristic of the nephrite jade powder, because it contains calcium, iron, magnesium, potassium, manganese, germanium, selenium, silicon and the like which are substantially identical to the components of nephrite jade powder. The amount of bentonite is preferably added in an amount that does not exceed the amount of nephrite jade powder added. Also, bentonite is preferably in such a small amount that does not impair the characteristics of nephrite jade powder. Bentonite is a kind of clay mineral that resulted in a process in which fine volcanic ashes generated by volcanic eruption were mixed with the high-altitude air current by a strong eruptive force and reacted with salt water in the sea. It is a clay mineral containing montmorillonite as a main component and contains large amounts of cationic mineral components, including calcium, iron, magnesium, potassium, manganese, germanium, selenium, silicon and the like. Thus, it is known that bentonite shows sterilizing effects by the cations and can be used as an environmentally friendly material in various products.

In the present invention, zeolite is added as an additive for improving the mineral characteristic of nephrite jade powder. For this reason, zeolite is preferably added in an amount that does not exceed the amount of nephrite jade powder added, and it is preferably added in such a small amount that does not impair the characteristics of nephrite jade powder. As widely known in the art, zeolite that is an aluminosilicate mineral contains about one million pores of less than 1 nm per area of μm². For this reason, zeolite in the present invention functions as a dehumidifying agent for entraining moisture or a heat insulation material containing air.

The matrix of the present invention is prepared by adding nephrite jade powder and bentonite or zeolite to synthetic resin (raw material) to obtain a mixture, heating the mixture, and molding the heated mixture by a conventional method to obtain a compound. Since nephrite jade and bentonite or zeolite are minerals having excellent heat resistance, they undergo no thermal change even in the heating process while maintaining the intrinsic properties thereof.

As examples of a synthetic resin used as a raw material of the matrix, thermoplastic synthetic resins include polyvinyl chloride (PVC), polyvinyl acetate (PVAC), polyvinyl alcohol (PVA, PVAL), polyvinyl acetal, polyvinyl formal (PVFM), polyvinyl butyral (PVB), polyvinylidene chloride (PVDC), polyvinylidene chloride-polyvinyl chloride copolymer, polyethylene (PE), polypropylene (PP), polystyrene (PS), styrene-butadiene copolymer (SB, HIPS), polystyrene foam (EPS, FS), acrylonitrile-styrene copolymer (AS, SAN), acrylonitrile-butadiene-styrene copolymer (ABS), ethylene-vinyl acetate copolymer (EVA), ionomer, polycarbonate (PC), polyvinyl ether-polyvinyl methyl ether, polyvinyl ketone, polytetrafluoroethylene (PTFE), polytrifluorochloroethylene (PCTFE), polyvinyl fluoride, polyvinylidene fluoride, tetrafluoroethylene-hexafluoropropylene copolymer, polyamide (PA, Nylon), polyacrylamide, polyacrylonitrile (AN), polyester, polyethylene terephthalate (PET), polybutyrene terephthalate (PBT), polyacetal, polyoxymethylene (POM), polyethylene oxide, polyphenylene oxide (PPO), polyacrylate (=polyacrylic ester), polymethacrylate (=polymethacrylic ester), polyurethane (PUR.AU.EU), polyphenylene sulfide (PPS), polysulfone (PSU), polymethacrylonitrile, or the like. Thermosetting synthetic resins include phenol-formaldehyde (PF), urea formaldehyde (UF), melamine-formaldehyde (MF), unsaturated polyester (UP), polydiallyl phthalate (PDAP, DAP), aniline-formaldehyde, epoly (EP), furan, xylene-formaldehyde, sulfonamide-formaldehyde, silicone (SI), polyurethane foam, formaldehyde resin, ketone resin, or the like.

The products made of the matrix of the present invention can be prepared, in case of the preparation of plastics, as plastic film (industrial use, agricultural use), plastic lump, plastic upperboard, plastic bar, pipe and profile, plastic leather, plastic conveyor belt, vinyl wall paper, recycled plastic raw material (powder phase), other plastic primary shaped products, and can be applied, in case of preparation of plastic foamed molded products, for foamed polystyrene (styrofoam etc.), and industrial foamed molded products (including soft and hard products).

For the reinforced plastic molded products, plastics including plastic machinery parts (adding durable, special reinforcing material), and other reinforced plastic molded products can be produced, and for industrial plastic shaping products, plastic electric and electronic machine parts, plastic autocar parts, plastic-made cabinet for home appliances (cabinet for T.V., audio or sewing machine), plastic furniture and other plastic industrial machine parts (pure plastics) can also be produced.

Also household plastic products such as plastic table and kitchen wares (tableware, dish, cup, knife, spoon and so forth), plastic hygiene and cosmetic articles (washbowl, bathtub, soap case, waste basket and so on), plastic button, plastic accessories and other household plastic molded products can be prepared, and plastic molded package vessels such as plastic box (fish box etc.), plastic bottle or similar vessels, and other plastic package vessels can be produced.

Namely, molded products made of the synthetic resin matrix of the present invention can be prepared as various products according to the classification based on the synthetic resin raw material as follows. PE: bottle, tube, wire coat, food package, film and pipe PS: doll, kitchen articles, tableware, insulating materials, material for packing, office supplies and parts for related industries such as autocar, electrics and electronics PP: container, pipe, film, artificial leather and parts for autocar AS: kitchen ware, telephone parts and pipe PVC: pipe, film, bottle, doll, disk, food container and wire coat Acryl: optical lens, autocar supplies and protecting plate for T.V. PA: bearing, hoses and film PC: electric parts Fluororesin: gasket and coatings for frying pan Polyester: various springs (elastic plate), usage for metal insert and gear bearing PF: telephone parts, electric goods, cup and car handle UF: button, lighting apparatus, clock, container, tableware and radio case MF: bathtub, button, safety hat and tableware Unsaturated Polyester: airplane parts, fuel tank, pipe, car body, helmet and fishing rod EP: autocar parts, electric parts and medical supplies PDAP: electric parts, terminal board and micro-switch board PUR: wire coat and rubber SI: tape, releasing agent and defoaming agent Furan: laminated plate and material for electric insulation Xylene: laminated plate molded goods Aniline: goods for electric insulation and laminated plate.

In addition, ABS, a high-quality resin which is positioned between common resin and engineering plastic, can produce exterior finishing material for electric and electronic goods, and autocar parts as well as telephone, radio, toys, dolls, and in agricultural field, protection for chicken stall against chilling, relieving agent for grain against vermin damage, vinyl house and pot for tree planting, in fishery field, container, artificial seaweeds and fishing implements (rope, fishing net, floating element), in food field, vessel and package for food, in medical field, blood vessel, the gullet, the urethra, the ureter and articulation used in inside of the body, and teeth, eyes, nose, ear and skin used in outside of the body, as well as syringe and diaper, in pharmaceutical field, granules with coating and tablets, in acoustic field, soundproofing agent and anti-vibration agent, in optical field, spectacle lens, contact lens, safety glasses, sun glasses and parts thereof, in textile field, nonwoven, carpet and rain coat in paper field, PE processed paper and plastic foam paper (ps paper), in office supplies field, equipment such as desk and chair, writing materials such as ball pen, in household goods field, tablewares such as kitchen board, dish washing stand and dish, table supplies, and goods for baby such as doll, toy and milk bottle, as well as basket, vegetable box and bathroom goods, in sports field, boat, sports car, skate, tennis racket and golf gloves, in machine field, axial arm, brake shoe, or the like in flight field, wings (main, rear, assist), fuselage, window, bulletin board and safety glass, in shipping field, ship, porthole frame, porthole and door for cabin, in autocar and vehicle field, safety glass, bumper, adiabatic material for car body and foamed cushion for sheet, in communication field, telephone, switchboard and terminal box for telephone, in electronic field, organic semiconductor, in electric field, electric fan, washing machine, television, radio, refrigerator and hairdressing tools, in building field, interior- and exterior-finishing materials such as ceiling material, wall material, floor material, tile and board for verandah, in engineering works field, admixture (for example, cement), water-protecting plate and tree-planting in desert, in information and printing fields, synthetic resin type, synthetic resin reprint, synthetic resin electric mold and magnetic tape, in atomic energy field, reaction vessel and various coating materials, in space development field, storage tank for liquid hydrogen and liquid oxygen, and in packing container field, plastic container and alternate plastic film.

Also, the synthetic resin products produced by using the matrix of the present invention may be applied to a variety of personal ornaments such as necklaces, bracelets, rings or the like, as well as utensil goods such as tableware.

The inventive matrix containing bentonite or zeolite together with nephrite jade powder has the effect of improving the physical strength and mechanical strength of articles formed therefrom.

Also, far-infrared rays beneficial to the human body, which are emitted from nephrite jade powder or bentonite, have the effects of activating human cell function, promoting blood circulation and metabolism, reducing indoor toxicity and removing odor.

In addition, zeoilite which is contained in the matrix of the present invention allows the matrix to function as a dehumidifying agent for entraining moisture or a heat insulation material. Thus, the matrix can be used in interior and exterior materials for construction.

### BRIEF DESCRIPTION OF THE DRAWINGS

The above and other objects, features and advantages of the present invention will be more clearly understood from the following detailed description taken in conjunction with the accompanying drawing, in which:

FIG. 1 is a scanning electron microscope (SEM) photograph showing the crystalline structure of nephrite jade powder contained in the matrix of the present invention;

FIG. 2 is a graph illustrating the far-infrared emissivity of nephrite jade used in the present invention, measured by an FT-IR spectrometer;

FIGS. 3A and 3B are typical chromatograms of a standard solution (A) used in the present invention and a microdialysis sample (B);

FIG. 4 shows the structure of a microdialysis probe site in the striatum used in the present invention (above) and in the nucleus accumbens (below);

FIG. 5 is a graph illustrating the effect of a nephrite jade distilled solution on dopamine release caused by methamphethamine in the striatum used in the present invention;

FIG. 6 is a graph illustrating the effect of a nephrite jade distilled solution on dopamine release caused by nicotine in the striatum used in the present invention;

FIG. 7 is a graph illustrating the change in activity of a test group (rats) after drinking nephrite powder jade water contained in the matrix of the present invention;

FIG. 8A is a SEM photograph of silk not treated with nephrite jade water contained in the matrix of the present invention;

FIG. 8B is a SEM photograph of silk not treated with nephrite jade water contained in the matrix of the present invention;

FIG. 8C is a SEM photograph of silk treated with nephrite jade water contained in the matrix of the present invention;

FIG. 8D is a SEM photograph of silk treated with nephrite jade water contained in the matrix of the present invention;

FIG. 9 is a graph showing the change in total volume of a culture of Digitalis lanata cells growing in growth medium;

FIG. 10 is a graph showing the change in volume of Digitalis lanata cells;

FIG. 11 is a graph showing the change in fresh weight of the cell;

FIG. 12 is a graph showing the change in dry weight of the cells;

FIG. 13 is a graph showing the change in pH of the culture medium for Digitalis lanata;

FIG. 14 is a graph showing the change in pH of the culture medium after adding nephrite jade powder;

FIG. 15 shows the conditions of the analytical instrument;

FIG. 16 shows the output results of the analysis;

FIG. 17 shows the change in pH of jade necklace and jade ore in ordinary purified water;

FIG. 18 shows the change in pH of jade necklace and jade ore in underground water with the passage of time;

FIG. 19 shows the change in pH of a strong acid solution according to treatment with nephrite jade powder collected in Choonchun-Shi, Kangwon-do, South Korea; and

FIG. 20 shows the change in pH of a strong acid solution stored in each of a nephrite jade powder-containing milk bottle and a general milk bottle with the passage of time.

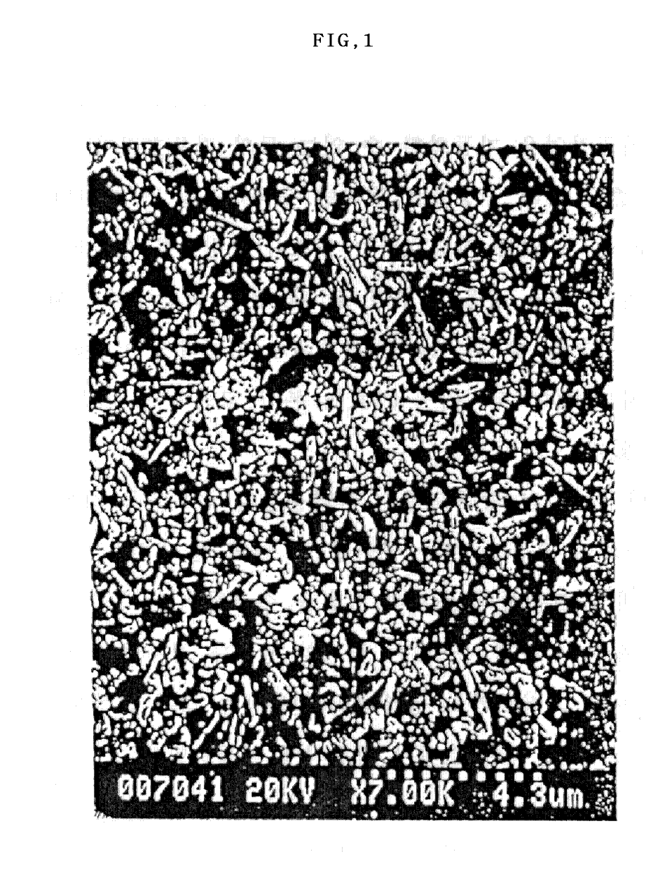

### DETAILED DESCRIPTION OF THE PREFERRED EMBODIMENT

Hereinafter, preferred embodiments of a matrix containing nephrite jade powder as a main component according to the present invention and a preparation method thereof will be described in detail.

### Example 1

1 wt % nephrite jade powder (collected in Choonchun-Shi, Kangwon-do, South Korea), having a particle size of 360 mesh, and 0.5 wt % of bentonite were added to a synthetic resin raw material for forming molded products, and the mixture was heated to 135° C. and molded according to a conventional process, thereby obtaining a matrix as a compound. The obtained matrix was injected into an injection molding machine through the hopper, and then heated to 100-130° C. to increase ductility, while it was pressed into molds. The molded articles were released from the molds due to opening of the molds, thus obtaining products of various types (a variety of vessels such as tableware, personal ornaments such as necklaces, bracelets or rings, sheets and other ornaments).

### Example 2

Various products (a variety of vessels such as tableware, personal ornaments such as necklaces, bracelets or rings, sheets and other ornaments) were produced in the same manner as in Example 1, except that 0.5 wt % of zeolite was added instead of bentonite.

### Example 3

Various products (a variety of vessels such as tableware, personal ornaments such as necklaces, bracelets or rings, sheets and other ornaments) were produced in the same manner as in Examples 1 and 2, except that 4.5 wt % of nephrite jade powder, having a particle size of 100 mesh, and 1 wt % of bentonite were added to a synthetic resin raw material for forming articles.

### Example 4

Various products (a variety of vessels such as tableware, personal ornaments such as necklaces, bracelets or rings, sheets and other ornaments) were produced in the same manner as in Example 3, except that 1 wt % of zeolite was added instead of bentonite.

The effect of nephrite jade powder contained as a main component in the above-prepared matrix could be confirmed through the following experimental examples. However, because the use of bentonite in cosmetic products and the use of zeolite as a filtering material for water purifiers are well known, experiments on the safety of bentonite or zeolite and on the effect thereof on the human body were omitted from the following experimental examples.

### Experimental Example 1

Experimental Examples shown in the following Tables through 4 were carried out to examine the effect of nephrite jade powder contained as the main component in the matrices prepared in Examples 1 to 4 of the present invention and to examine the effect of the nephrite jade powder on the human body.

TABLE 1
Test for lead content

| | |
|---|---|
| Sample | Jade powder |
| Appearance | White powder |
| Working No. | Research institute attached to |
| | the FDA of US IW 091394-1 |
| Experimental method | Atomic absorption analysis |
| Results | Not detected |

TABLE 2
Test for heavy metals (including Pb)

| | |
|---|---|
| Sample | Jade powder |
| Appearance | White |
| Working No. | IW 080894-4 |
| Experimental method | USP 23 |
| Results | Not detected |

TABLE 3
Test for dissolution of inorganic materials

| | |
|---|---|
| Sample | Jade powder |
| Appearance | White |
| Working No. | IW 080894-4 |
| Experimental method | Described below |
| Results | Described below |

100 g of the sample was extracted with 1 liter of water in an autoclave, and the extract was analyzed.

TABLE 4

| Analyzed | Result | Detection limit |
|---|---|---|
| material | (ppm) | (ppm) |
| Arsenic (As) | ND | 0.05 |
| Barium (Ba) | ND | 0.20 |
| Cadmium (Cd) | 0.007 | 0.005 |
| Chlorine (Cl) | ND | 1 |
| Chromium (Cr) | ND | 0.01 |
| Copper (Cu) | ND | 0.05 |
| Iron (Fe) | ND | 0.10 |
| Lead (Pb) | ND | 0.05 |
| Manganese (Mn) | ND | 0.02 |
| Mercury (Hg) | ND | 0.0005 |
| Nitrate (NO3) | ND | 0.1 |
| Selenium (Se) | ND | 0.05 |
| Silver (Ag) | ND | 0.01 |
| Sulfate (SO4) | ND | 1 |
| Zinc (Zn) | ND | 0.01 |

(ND = not detected, or the concentration lower than the detection limit)

(ND=not detected, or the concentration lower than the detection limit)

As can be seen in the experimental results, the nephrite jade powder used in the present invention did not contain lead, heavy metals or other materials, which are harmful to the human body. This suggests that the nephrite jade powder is safe when it is used in tableware, nipples for nursing bottles, etc.

### Experimental Example 2

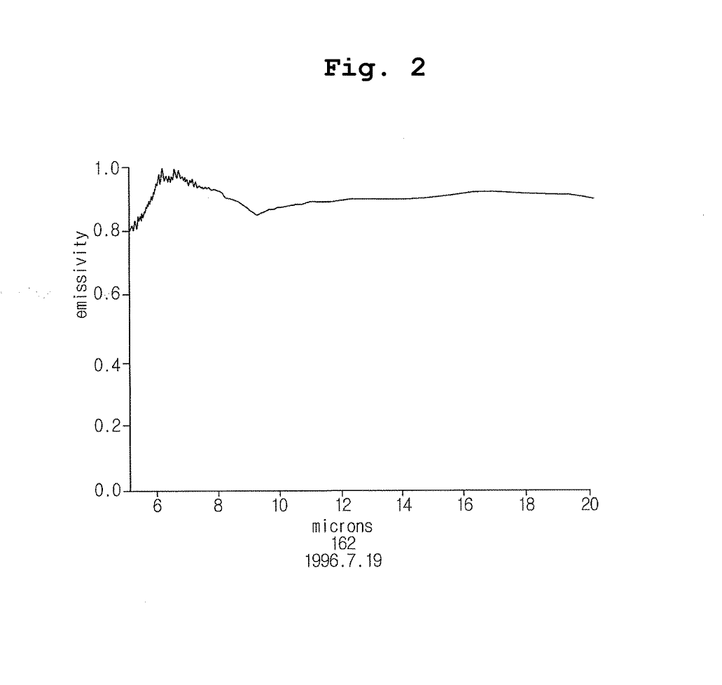

A far infrared experiment on nephrite jade powder was carried out (FIG. 2).

TABLE 5

| | |
|---|---|
| Sample | Jade powder |
| Appearance | White |
| Experimental method | Perkin Elmer 137 |
| Results | Described below |

IR condition:

Phase: Tetrahydrofuran liquefied thin film.

Results: The IR spectrum appeared to conform to polycarbonate resin patterns and showed that the jade powder emitted electromagnetic waves a wavelength of having 6-52 μm.

### Experimental Example 3

The chemical oxygen demand (COD) and biochemical oxygen demand (BOD) of the nephrite jade powder sample used in the present invention were tested as shown in the following Tables 6 and 7.

TABLE 6

| | |
|---|---|
| Sample | Nephrite jade powder |
| Appearance | White |
| Experimental method | Standard method |
| Results | Shown in Table 7 below |

TABLE 7

| | | Treated with |
|---|---|---|
| | Water (control) | nephrite jade powder |
| BOD for 5 | 224 mg/l | 223 mg/l |
| days | | |
| COD | 115 mg/l | 110 mg/l |

Then, based on the results of the above experimental examples, the physical properties of a molded article (vessel) from the matrix obtained in Example 1 or 2 and those of conventional resin products were tested, and the test results are shown in Tables 8 and 9 below.

TABLE 8

| | Article of the | Conventional | Conventional |
|---|---|---|---|
| | present invention | article (1) | article (2) |
| Hardness | 80 | 45 | 60 |
| (Shore A) | | | |
| 250° C., 24 hr | | | |
| Tensile | 120 | 86 | 70 |
| strength | | | |
| (kg/cm²) | | | |
| 250° C., 24 hr | | | |
| Elongation (%) | 350 | 340 | 200 |
| 250° C., 24 hr | | | |

TABLE 9

| | | Article of | | |
|---|---|---|---|---|
| | | the present | Conventional | Conventional |
| | | invention | article (1) | article (2) |
| Thermal | Tensile | −1.1 | −9.2 | −8.2 |
| change (%) | strength | | | |
| at 250° C. | Elongation | −1.0 | −4.0 | 70 |
| for 72 hr | Hardness | +1.7 | +10.0 | +15.0 |

As can be from the above results, the heat resistance and physical strength of the article prepared according to the present invention was improved compared to those of conventional resin articles.

Through Experimental Examples 4 and 5 below, it can be seen that various products containing nephrite jade powder have medical effects.

### Experimental Example 4

To examine how the products (e.g., ornaments such as necklaces, rings and bracelets) produced in Examples 1 and 2 are beneficial to the human body, an experiment was carried out by the Oriental Hospital of Daejeon University, Daejeon, South Korea.

In the experiment, adult men and women, who were over 45 years old and have worn general ornaments, were caused to use the ornaments of the present invention for 2 hours or more, and then changes in the human body were measured. The measurement results are shown in Tables 10 to 12 below.

TABLE 10
Tests for 45-year old adult men

| | | General | Ornaments of the |
|---|---|---|---|
| | | ornaments | present invention |
| Heart rate (SaO2) | | 81 BPM | 76 BPM |
| Blood | NIBP | 127 mmHg | 128 mmHg |
| pressure | systolic | | |
| | Mean | 107 mmHg | 104 mmHg |
| | Diastolic | 80 mmHg | 76 mmHg |

| | | |
|---|---|---|
| Oxygen | 91% | 93% |
| concentration | | |
| (SaO2) | | |
| (Pulse | 81 BPM | 76 BPM |

TABLE 11
Tests for 55-year old adult men

| | | General | Ornaments of the |
|---|---|---|---|
| | | ornaments | present invention |
| Heart rate (SaO2) | | 81 BPM | 85 BPM |
| Blood | NIBP | 181 mmHg | 173 mmHg |
| pressure | systolic | | |
| | Mean | 142 mmHg | 127 mmHg |
| | Diastolic | 111 mmHg | 110 mmHg |

| | | |
|---|---|---|
| Oxygen | 95% | 95% |
| concentration | | |
| (SaO2) | | |
| Pulse | 83 BPM | 85 BPM |

TABLE 12
Tests for 64-year old adult women

| | | General | Ornaments of the |
|---|---|---|---|
| | | ornaments | present invention |
| Heart rate (SaO2) | | 68 BPM | 68 BPM |
| Blood | NIBP | 185 mmHg | 176 mmHg |
| pressure | Systolic | | |
| | Mean | 117 mmHg | 125 mmHg |
| | Diastolic | 104 mmHg | 105 mmHg |

| | | |
|---|---|---|
| Oxygen | 74% | 96% |
| concentration | | |
| (SaO2) | | |
| (Pulse | 68 BPM | 68 BPM |

As can be seen from the results shown in Tables 10 to 12, the oxygen concentration was higher in those who worn the ornaments of the present invention than in those who worn the general ornaments. This suggests that the ornaments of the present invention have excellent effects of promoting metabolism and making blood circulation smooth.

### Experimental Example 5

The sheets prepared in the above Examples of the present invention were placed on beds, Korean under-floor heating systems, sofas, chairs and the like which were allowed to be used by patients, and in this state, clinical tests were performed. The clinical test results showed that the sheets of the present invention were effective for about 88% of the patients.

Criterion and Method for Selecting Test Subjects

Among hospitalized patients who have been treated in the Oriental Hospital of Daejeon University, 25 patients suffering from symptoms including headache, insomnia, dizziness, uneasiness or numbness were selected as clinical test subjects.

Observation Items and Method

Hospitalized patients suffering from symptoms of headache, insomnia, dizziness, uneasiness or numbness were allowed to use the sheets of the present invention, and then the patient's physical conditions and changes were observed.

Evaluation Criteria and Method

A. Evaluation criteria: based on conditions at the first medical examination for observation items

B. Evaluation method: described in Table 13 below. The evaluation results are shown in Table 14 below.

TABLE 13

| Order | Effect | Evaluation (%) |
|---|---|---|
| 1 | Insignificant or no | Less than 70% |
| | effect | |
| 2 | Effective | Moe than 70% |
| 3 | Considerable effect | More than 80% |
| 4 | Almost perfect cure | More than 90% |

TABLE 14

| | Insignif- | | Consid- | Almost | |
|---|---|---|---|---|---|
| | icant or | Effec- | erable | perfect | |
| | no effect | tive | effect | cure | |
| | Less | More | More | More | |
| Symptom | than 70% | than 70% | than 80% | than 90% | Total |
| Headache or | 2 | 3 | 5 | 1 | 11 |
| dizziness | | | | | |
| Insomnia | 0 | 2 | 1 | 1 | 4 |
| Uneasiness | 1 | 1 | 1 | 2 | 5 |
| Numbness | 0 | 1 | 1 | 1 | 3 |
| Indigestion | 0 | 0 | 2 | 0 | 2 |
| Total | 3(12%) | 7(28%) | 10(40%) | 5(20%) | 25(100%) |

As can be seen in the results of Table 14, symptoms of headache, dizziness, insomnia, uneasiness or numbness in most of the patients subjected to the clinical tests get better.

### Experimental Example 6

In this Experimental Example, necklaces (with large beads), made of nephrite jade used in the present invention, and nephrite jade tea were used by approximately 39-years old healthy men and approximately 19-years old women, and then the test subjects were measured for four typical items by a radionic biofield analyzer (commercially available under the trade name of OMNI-SENSE). Then, the change in the biorhythm was analyzed. The measurement results are shown in Tables 15 and 16 below.

TABLE 15
Jade necklace (with large beads)

| | |
|---|---|
| Man (40 years old) | Woman (19 years old) |

| Before use | After use | Before use | After use |
|---|---|---|---|
| Angina (50121) | 43 | 43 | 45 |
| Diabetes | 35 | 37 | 54 |
| (10932) | | | |
| Hypertension | 44 | 45 | 44 |
| (45031) | | | |
| Sciatic nerve | 24 | 53 | 54 |
| (42812) | | | |

*Numbers in parentheses denote intrinsic measurement codes of radionic biofield analyzer (OMNI-SENSE).

TABLE 16
Nephrite jade tea

| | Man (40 years old) | | Woman (21 years old) | |
|---|---|---|---|---|
| | Before use | After use | Before use | After use |
| Angina (52071) | 53 | 64 | 35 | 44 |
| Diabetes | 47 | 53 | 42 | 43 |
| (11009) | | | | |
| Hypertension | 48 | 57 | 33 | 41 |
| (40520) | | | | |
| Sciatic nerve | 43 | 61 | 23 | 52 |
| (40228) | | | | |

*Numbers in parentheses denote intrinsic measurement codes of radionic biofield analyzer (OMNI-SENSE).

As can be seen in the results of Tables 15 and 16, there was a great difference in the values measured by the radionic biofield analyzer before and after use of jade. A higher value means that the jade components are more beneficial to the human body. Although the above-described experimental example was performed on healthy people, it is expected that, if the experiment is performed on patients, a greater difference in the measured values can be observed. The radionic biofield analyzer used in the experiment is a combined analyzer of a traditional analog radionic biofield analyzer and a digital radionic biofield analyzer. The analyzer employs a pocket computer (64 kb), and rates of about 400 basic items for determining the physical conditions of the human body, including balance of Yin and Yang, hormone balance, metabolic disorders, vitamin deficiency, mineral deficiency, senses and the like, are programmed in the pocket computer.

The reference values of the radionic biofield analyzer and measurement conditions are as follows.

TABLE 17
Reference values of the radionic biofield analyzer

| | |
|---|---|
| 0-25% | Bad |
| 25-45% | Good |
| 45-55% | Very good |
| 55-75% | Bad |
| 75-100% | Bad |

<Error Tolerance of the Radionic Biofield Analyzer>

±5% allowed according to the environment of a measurement place and the analyzing person's physical condition

### <Measurement Range of the Radionic Biofield Analyzer>

Ranging from −100 to +100%, normally ranging from 0 to 100%

### <Measurement Environment>

EMI-free place, optimally a place where no interference from other strong waves occurs

### <Power>

Compatible for both 220 V AC adapter and built-in batteries (A4×4)<

### Experimental Example 7

In this Experimental Example, the effect of nephrite jade distillate (i.e., nephrite jade extract), obtained using nephrite jade in the present invention, on brain function, was performed by the division of Nuclear Medicine, Samsung Seoul Hospital. The experimental methods and results are as follows.

A. Preparation of Sample

A sample (nephrite jade distillate) was prepared by mixing nephrite jade ore (pre-treated by crushing, screening and washing) with purified water at a ratio of 1:4, placing the mixture into an evaporator, heating the mixture to a high temperature of 100° C. or higher, evaporating a jade ore-containing material, which is eluted from the jade ore into the purified water during the heating, together with the distilled water to obtain steam, and then converting the steam including the jade ore-containing material into a distillate by heat exchange.

B. Effect of Jade Extract of the Present Invention On Dopamine Release Caused by Methamphetamine

1) Experimental Animals

An in vivo microdialysis experiment was carried out using male Sprague-Dawley white rats (280-320 g, Korea Experimental Animal Center). The animals were housed in cages with free access to food and water under a 12-hr light/12-hr dark cycle.

2) In Vivo Microdialysis Experiment

a) Treatment with Drug

To investigate the effect of the jade extract on the dopamine release caused by methamphetamine, 0.5 ml of the nephrite extract of the present invention was intraperitoneally injected 60 minutes before intraperitoneal injection of methamphetamine (10 mg/kg, i.p.), and then dialysate samples were collected from the striatum.

b) Surgery and Microdialysis

The experimental animals were anesthetized with pentobarbital (50 mg/kg, i.p.), and then a guide cannula was aseptically inserted into the striatum (Sterotaxic coordinates: AP 1.0 and L 3.2 with respect to bregma, and H 3.0 with respect to dura mater) according to the atlas of Paxinos & Watson (1986) and fixed using a microthread and dental cement. After a 24-hour recovery period, a 4 mm vertical microdialysis probe (CMA-12, Carnegie-Medicine, Stockholm, Sweden) was inserted through the guide cannula. The inlet of the microdialysis probe is connected to a syringe mounted on a perfusion pump via a dual liquid rotary ring. While artificial cerebrospinal fluid (containing 145 mM NaCl, 2.7 mM KCl, 1.2 mM CaCl₂, 1.0 mM MgCl₂, 2.0 mM Na₂HPO₄; pH 7.4) was injected at a rate of 1.5 μl/min through the microdialysis probe, dialysates were collected at 20-min intervals using a microfraction collector (Carnegie-Medicine) connected to the outlet of the microdialysis probe. The microdialysis experiment was carried out on the experimental animals that were allowed to move freely.

c) Analysis of Microdialysate Sample

The concentrations of monoamines and metabolites of the microdialysate samples were assayed by a HLPC-electrochemical detection (ECD) system. The dialysate (30 μl dose) was separated using a reverse-phase Waters Nova-Pak C-18 column (4 μm, 150×3.9 mm). The mobile phase consisted of 75 mM sodium phosphate, 0.12 mM EDTA, 1.4 mM octansulfonic acid and 10% acetonitrile. It was adjusted to a pH of 3.2 with phosphoric acid. The HPCL peak was analyzed using an ESA Coulochem II 5200A electrochemical detector equipped with a high-performance analysis device (ESA model 5014). The electrode potential was set at +320 mV. The flow rate of the system was 1.0 ml/min.

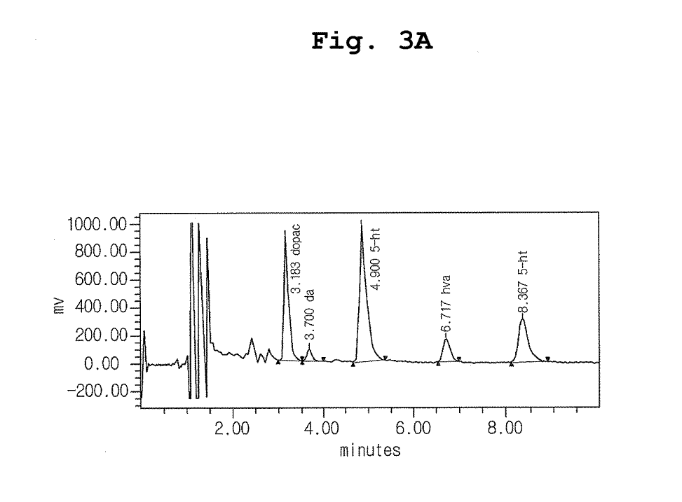

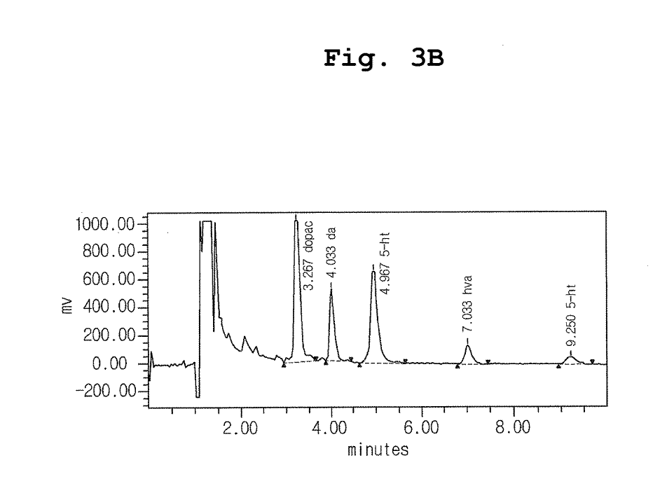

Typical chromatograms obtained from the standard solution and microdialysate samples are shown in FIG. 3. Dopamine, dihydroxyphenylacetic acid (DOPAC), homovanillic acid (HVA), 5-hydroxytrymptamine (5-HT), 5-hydroxyindoleacetic acid (5-HIAA) were distinctly separated. The dopamine concentration of the dialysate was more than 3 times the minimum measurement limit (116 μM). The basal concentrations of dopamine, DOPAC, HVA, 5-HT and 5-HIAA were 18.5 nM, 90.5 nM, 74.7 nM, 6.2 nM and 45.6 nM, respectively. Since the dopamine recovery rate of the microdialysis probe, obtained by ex vivo experimentation, was 20%, the extracellular dopamine level was estimated to 92.5 nM. The average dopamine concentration of last three samples collected immediately before experimental treatment was used as the baseline, and the dopamine level of the dialysate was expressed as a percentage relative to the baseline.

d) Histological Analysis

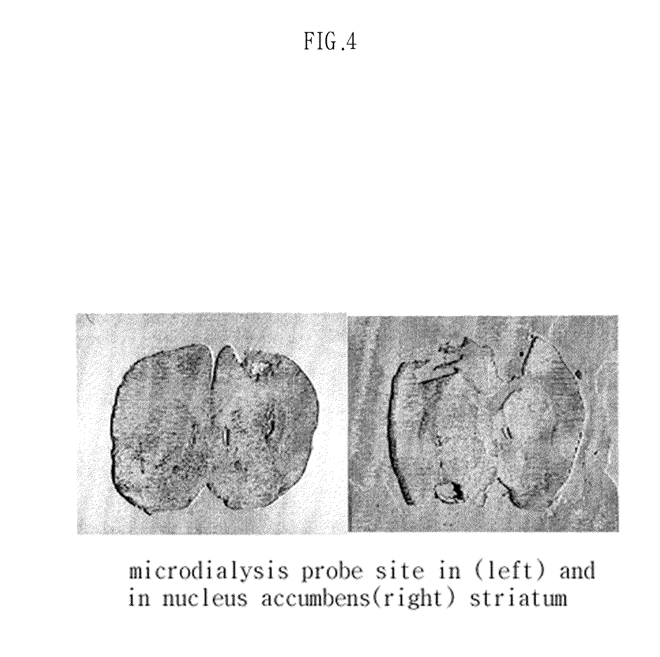

After completion of the experiment, the experimental animals were deeply anesthetized by pentobarbital, and then infused with physiological saline solution and 10% formalin solution through the heart, and then decerebrated. The removed brains were stored in 10% formalin solution for at least 2 weeks. Then, tissues of the site where the microdialysis probe has been positioned were cut to a thickness of 50 μm, and the position of the probe was determined by hematoxylin staining (FIG. 4).

e) Statistical Analysis

All the measurements were expressed as mean±standard deviation. The statistical significance of data was analyzed using two-way ANOVA with repeated measurements (drug×time) and the Bonferroni method. The statistics analysis software StarView 4.02 (Abacus Concepts, Inc., Berkely, Calif., U.S.A.) and Macintosh computers were employed. The statistical significance was determined based on P<0.005.

3) Study Results

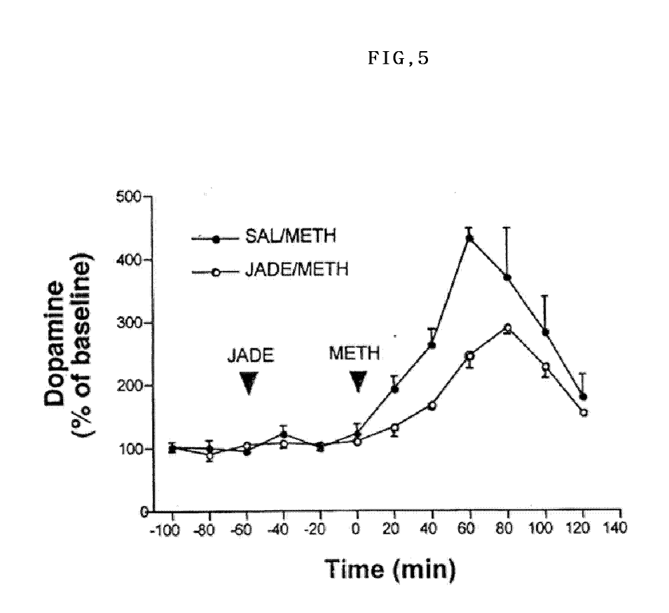

FIG. 5 shows the effect of the nephrite jade extract (distillate) on dopamine release caused by methamphetamine in the striatum. After injection of methamphetamine (10 mg/kg, i.p.), the extracellular concentration of dopamine gradually increased to reach a peak in 60 minutes (433.6±14.3% of baseline) (mean±standard deviation). When 0.5 ml of the nephrite jade extract was intraperitoneally injected 60 minutes prior to injection of methamphetamine, the increase in the extracellular concentration of dopamine in the striatum, caused by methamphetamine, was inhibited by 32.8% (29.15±11.4% of baseline). Also, the injection of the nephrite jade extract delayed the time required to reach the maximum level of dopamine after injection of methamphetamine (80 minutes after injection of methamphetamine). Meanwhile, the nephrite jade distillate according to the present invention did not influence the extracellular concentration of dopamine in the stable striatum.

C. Effect of Jade Extract on Dopamine Release Caused by Nicotine

1) Experimental Animals

An in vivo microdialysis experiment was carried out using male Sprague-Dawley white rats (280-320 g, Korea Experimental Animal Center). The animals were housed in cages with free access to food and water under a 12-hr light/12-hr dark cycle.

2) In Vivo Microdialysis Experiment

a) Treatment with Drug

To investigate the effect of the jade extract of the present invention on dopamine release caused by nicotine, 0.5 ml of the nephrite jade extract was intraperitoneally injected 60 minutes before injection of nicotine (0.4 mg/kg, subcutaneous injection), and then dialysate samples were collected from the striatum.

b) Surgery and Microdialysis

The experimental animals were anesthetized with pentobarbital (50 mg/kg, i.p.), and then a guide cannula was aseptically inserted into the striatum (Sterotaxic coordinates: AP 1.0 and L 3.2 with respect to bregma, and H 3.0 with respect to dura mater) according to the atlas of Paxinos & Watson (1986) and fixed using a microthread and dental cement. After a 24-hour recovery period, a 4 mm vertical microdialysis probe (CMA-12, Carnegie-Medicine, Stockholm, Sweden) was inserted through the guide cannula. The inlet of the microdialysis probe is connected to a syringe mounted on a perfusion pump via a dual liquid rotary ring. While artificial cerebrospinal fluid (containing 145 mM NaCl, 2.7 mM KCI, 1.2 mM CaCl₂, 1.0 mM MgCl₂, 2.0 mM Na₂HPO₄, pH 7.4) was injected at a flow rate of 1.5 μl/min through the microdialysis probe, dialysates were collected at 20-min intervals using a microfraction collector (Carnegie-Medicine) connected to the outlet of the microdialysis probe. The microdialysis experiment was carried out on the experimental animals that were allowed to move freely.

c) Analysis of Microdialysate Samples

The concentrations of the microdialysate samples were assayed by a HLPC-electrochemical detection (ECD) system. The dialysate (30 μl dose) was separated using a reverse-phase Waters Nova-Pak C-18 column (4 μm, 150×3.9 mm). The mobile phase consisted of 75 mM sodium phosphate, 0.1 mM EDTA, 1.4 mM octansulfonic acid and 10% acetonitrile. It was adjusted to a pH of 3.2 with phosphoric acid. The HPCL peak was analyzed using an ESA coulochem II 5200A electrochemical detector equipped with a high-performance analysis device (ESA model 5014). The electrode potential was set at +320 mV. The flow rate of the system was 1.0 ml/min. The average dopamine concentration of last three samples collected immediately before experimental treatment was used as a baseline, and the dopamine concentration of the dialysate was expressed as a percentage relative to the baseline.

d) Histological Analysis

After completion of the experiments, the experimental animals were deeply anesthetized by pentobarbital, and then the animals were perfused with physiological saline solution and 10% formalin solution through the heart, and then decerebrated. The removed brains were stored in 10% formalin solution for at least 2 weeks. Then, tissues of the site where the microdialysis probe has been positioned were cut to a thickness of 50 μm, and the position of the probe was determined by hematoxylin staining.

e) Statistical Analysis

All the measurements were expressed as mean±standard deviation. The statistical significance of data was analyzed using two-way ANOVA with repeated measurements (drug×time) and the Bonferroni method. The statistical significance was determined based on P<0.005.

3) Study Results

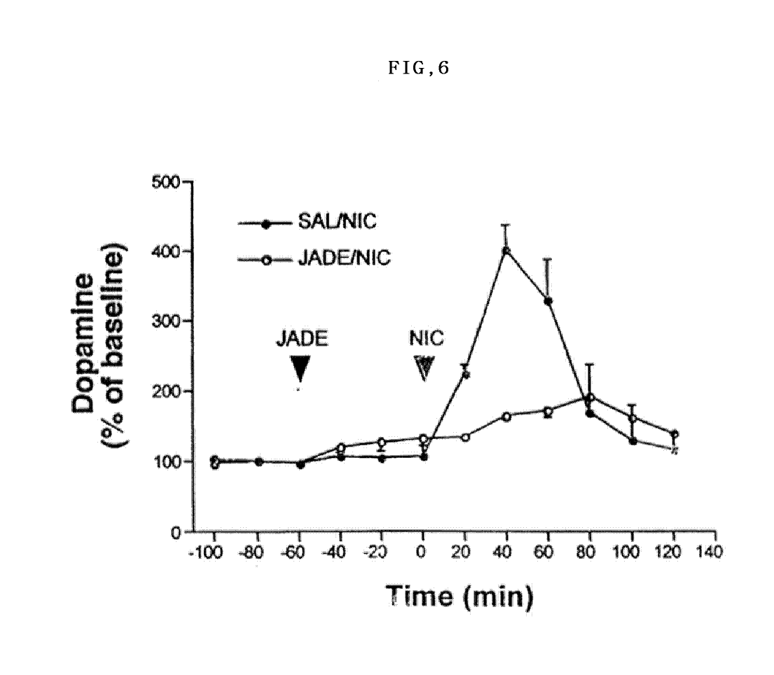

FIG. 6 shows the effect of the nephrite jade extract (distillate) on dopamine release caused by nicotine in the striatum. After infusion of nicotine (0.4 mg/kg, subcutaneous injection), the extracellular concentration of dopamine gradually increased to reach a peak in 40 minutes (403.9±33.2% of baseline) (mean±standard deviation), and then decreased to be restored to the baseline level in 120 minutes. When 0.5 ml of the nephrite jade distillate was intraperitoneally injected 60 minutes prior to nicotine infusion, the increase in the extracellular dopamine concentration in the striatum, caused by nicotine, was inhibited by 52.0% (193.9±6.1% of baseline). Also, the injection of the nephrite jade extract (distillate) delayed the time required to reach the maximum level of dopamine after infusion of nicotine (80 minutes after injection of nicotine). Meanwhile, the nephrite jade extract did not influence the extracellular concentration of dopamine in the stable striatum.

The experimental results indicated that the nephrite jade extract of the present invention inhibited dopamine release caused by methamphetamine and nicotine in the striatum of white rats.

### Experimental Examples 8 and 9

In this experiment, the effects of a nephrite jade-containing space and jade water containing nephrite jade powder precipitated therein on the propagation and growth of white rats were tested by the Korea Food Research Institute. The details are described below.

### Experimental Example 8

To examine the relieving effect of nephrite jade on streptozotocin-induced diabetes in white rats, the experiment was performed by the Korea Food Research Institute. The details are described below.

Thirty-two (32) Sprague Dawley rats weighing 252-292 g were intraperitoneally administered with streptozotocin (35-40 mg/kg dissolved in 0.1M citrate buffer of pH 4.0) to induce diabetes. Seven days after administration of streptozotocin, rats showing a urine glucose level higher than 250 mg/dl were selected using uropaper (Eiken Chemical Co., Ltd., Japan), and divided into four experimental groups, each consisting of five animals, and then tested for 50 days. The animals of group A were intraperitoneally injected with 1.0 ml of the nephrite jade distillate (pH 6.40) of the present invention each day. The rats of group B were housed in cages containing nephrite jade material. The rats of group C were fed with a supernatant of nephrite jade water as drinking water every day after precipitation of nephrite jade powder. The rats of group D as a control were injected only with streptozotocin. During the experimental period, the rats were fed with a commercial rat chow and cared according to the general practices. The rats were sacrificed on day 50, and blood was collected from the abdominal aorta. The blood was left to stand at room temperature for 30 minutes, and then centrifuged at 5,000 rpm for 15 min to collect plasma. The weights of the isolated organs (liver, kidney, etc.) were measured and recorded. The contents of HBA (plasma β-hydrroxybutyrate), FFA (free fatty acids), cholesterol, HDL-cholesterol and triglyceride in the plasma were measured. The content of HBA was quantitatively analyzed by measuring the increase in absorbance (OD) at 340 nm of NADH produced by oxidation with β-hydrroxybutyrate dehydrogenase. Lipids in the blood were analyzed by a clinical kit (Eiken Chemical Co., Ltd., Japan).

TABLE 18
Effects of nephrite jade on the body weight and organ
weight of streptozotocin-induced diabetic rats

| | Body weight (g) | | Organ weight (g/100 g | |
|---|---|---|---|---|
| | Before | After | body weight) | |
| Group | experiment | experiment | Liver | Kidney |
| A | 270.4 ± 11.3 | 271.7 ± 49.4 | 4.31 ± 0.33 | 1.02 ± 0.12 |
| B | 284.8 ± 6.1 | 279.6 ± 20.4 | 4.30 ± 0.64 | 1.01 ± 0.18 |
| C | 280.4 ± 13.2 | 315.7 ± 41.1 | 3.96 ± 0.75 | 0.87 ± 0.14 |
| D | 257.2 ± 4.2 | 194.8 ± 26.3 | 4.37 ± 0.19 | 0.78 ± 0.04 |

TABLE 19
Effects of nephrite jade on the biochemical indices of streptozotocin-induced diabetic rats

| | Glucose | HBA^{a} | FFA^{b} | TC^{c} | TG^{d} | HDL^{e} |
|---|---|---|---|---|---|---|
| Group | (mg/100 ml) | (μmol/ml) | (μeq/ml) | (mg/100 ml) | (mg/100 ml) | (mg/100 ml) |
| A | 639.2 ± 99.0^{a} | 0.782 ± 0.481^{a} | 507.6 ± 226.6^{a} | 166.2 ± 69.4 | 410.7 ± 50.1 | 32.35 ± 5.94 |
| B | 495.1 ± 228.1^{ab} | 0.527 ± 0.296^{ab} | 349.5 ± 79.2^{ab} | 161.3 ± 45.3 | 122.5 ± 43.5 | 29.49 ± 1.71 |
| C | 354.1 ± 154.2^{bc} | 0.425 ± 0.172^{ab} | 287.3 ± 71.7^{b} | 145.4 ± 29.1 | 87.9 ± 29.2 | 30.55 ± 8.28 |
| D | 196.8 ± 16.3^{d} | 0.276 ± 0.036^{b} | 291.0 ± 131.2^{b} | 158.2 ± 12.2 | 86.8 ± 3.4 | 31.37 ± 3.84 |

p < 0.05
^{a}β-hydrroxybutyrate (ketone body)
^{b}Free fatty acid
^{c}Total-cholesterol
^{d}Triglyceride (neutral lipid)
^{e}High-density lipoprotein cholesterol

The body weight was increased in group C fed with nephrite jade water, whereas it was decreased in groups B and C or maintained in group A. It is known that kidney hypertrophy generally occurs in diabetic rats. This tendency was also increased in this study, and the kidney weight of group C was the lowest among the groups except for the control group. Liver hypertrophy appeared due to diabetic induction, but the liver weight was the lowest in the rats fed with jade water. The concentrations of blood glucose, ketone body and FFA were higher in the order of groups A, B, C and D. Blood plasma cholesterol and triglyceride concentration had followed the same tendency (A>B>C>D) as the above parameters mentioned. From these results, all the indices of the rats fed with nephrite jade water (group C) were relatively low compared to those of the other two experimental groups, and blood cholesterol and FFA concentrations were lower in the group C rats than in the control group rats not treated with nephrite jade. TC and TG concentrations were in the order of A>B>C>D. The results of glycemic index by blood sugar reaction after meal vary depending on the researchers. However, in the experiment, though commercial blended feed (TMR) was fed without considering glycemic index of cereals, the group C rats fed with jade water showed the effect of alleviating hyperlipidemia, one of diabetic symptoms. There was no difference in HDL-cholesterol concentration between the experimental groups. In conclusion, the administration of vapor-phase nephrite jade material and nephrite jade distillate to Streptozotocin-induced diabetic rats could prevent weight loss, prevent enlargement of kidney or liver and alleviate hyperlipidemia, one of diabetic symptoms.

### Experimental Example 9

Thirty male and thirty female Sprague Dawley rats (9 weeks old) were prepared and divided into three groups. The rats of group A were housed in the cage into which the air containing vapor-phase nephrite jade was introduced, and the rats were provided with tap water. The rats of group B were fed with a supernatant after precipitation of nephrite jade powder (2 mg/ml tap water), but no vapor-phase nephrite jade was injected into the cage. The rats of group C were used as a control group (no vapor-phase nephrite jade and no nephrite jade water). The rats were mated for nine days, and then the male rats were separated and sacrificed for sperm concentration and motility tests. The results are shown in Table 20 below.

TABLE 20
Effects of nephrite jade material on propagation and growth of rats

| Group | A | B | C |
|---|---|---|---|
| Parturition (No. | 9 | 9 | 8 |
| of rats) | | | |
| Litter number | 96 (57/39) | 94(57/37) | 102 (54/48) |
| (♂/♀) | | | |
| Litter number | 11.8 ± 1.9 | 10.9 ± 1.4 | 12.8 ± 2.1 |
| (head/♀) | | | |
| Body weight at | 4.73 ± 1.10 | 5.79 ± 0.95 | 5.35 ± 0.35 |
| birth (g) | | | |
| Mortality | 4 | 4 | 3 |
| (animals ) | | | |
| Days from mating | 23.8 ± 1.4 | 25.1 ± 1.7 | 25.5 ± 3.7 |
| to parturition | (n = 10) | (n = 9) | (n = 8) |
| Body weight at | 43.45 ± 8.04 | 42.73 ± 8.76 | 42.07 ± 10.71 |
| weaning (g) | | | |
| Body weight at | 294.0 ± 10.9 | 274.4 ± 8.6 | 288.4 ± 26.7 |
| slaughter (g) | | | |
| Testis weight (g) | 3.90 ± 0.21 | 3.57 ± 0.30 | 3.99 ± 0.15 |
| Sperm | 6.32 ± 2.4 | 4.80 ± 1.3 | 4.60 ± 1.9 |
| concentration | | | |
| (10⁸/ml) | | | |
| Sperm motility | 91.0 ± 4.2 | 92.0 ± 2.7 | 88.0 ± 7.6 |
| (%) | | | |

In the experimental examples, group A administered with nephrite jade material and group B treated with jade water showed better parturition records. Specifically, the parturition rates of groups A and B (90%) were higher than that of group C (80%), and the litter number was larger by 3-4 animals than in groups A and B, but the number of male litters was larger by 3 animals in each of groups A and B. The length of time from mating to parturition was significantly shorter in the group A rats than the other two groups. Besides these findings, the sperm concentration and motility in group A fed with nephrite jade material were excellent. However, the effects of treatment with both nephrite material jade material and jade water were not investigated in this study. In conclusion, the results suggest that nephrite jade material and jade water influence the propagation and growth of rats. The groups fed with nephrite jade material or treated with jade water were superior propagation and growth indices.

### Experimental Example 10

This experiment was carried out examine the change in the activity of rats provided with jade water containing the nephrite-jade powder of the present invention.

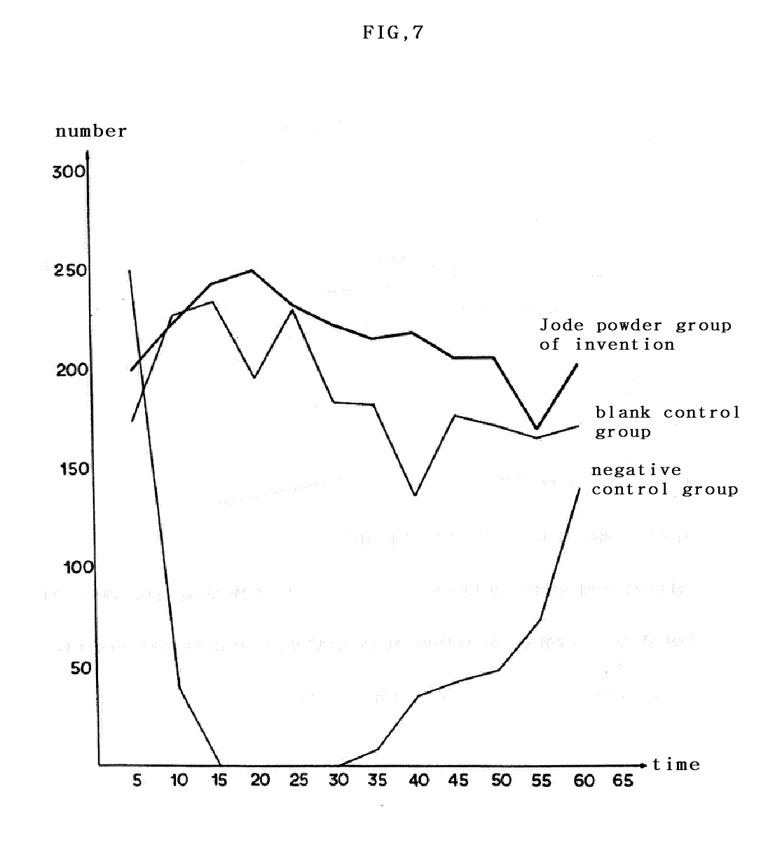

As shown in FIG. 7, in the stability experiment, the central nerve of the rats of the positive control group began to become stable in 5 minutes later after taking a Chinese medicine (Ubabito in Chinese) and then was completely recovered to the normal state after 30 minutes. The rats of the general control group showed an undulating change in their activity rate, showing a decreasing tendency on the whole. The activity rate of the rats in the jade water drinking group was similar to that of the general control group, showing an average activity rate higher than that of the general control group, and significantly higher than that of the mediated group.

### Experimental Example 11

This experiment was carried out to examine the effects of jade on the growth rate, sperm motility and quantity of muscular motion when a diet and the water provided from the purifier and refrigerator including an interior material prepared in the above Examples were fed to test groups (white rats).

The experimental animals were divided into: a control group (A) fed with the water provided from a general purifier and a diet stored in a general refrigerator; and a jade-treated group (B) fed with the water provided from a jade purifier and a diet stored in a refrigerator including a jade-containing interior material. Each test group consisted of 9 white rats (about 10 weeks old) (3×3 repetition), and thus a total of 18 rats were used in the experiment. The rats were reared for 6 weeks, and the growth rate, sperm motility, sperm concentration, blood lipid concentration and quantity of motion of the rats were measured as shown in Table 21 below.

TABLE 21

Group*

| | Control group | Jade-treated group |
|---|---|---|
| | (A) | (B) |
| Measurement items | | |
| Growth rate (g/day) | 2.33 ± 0.37 | 2.64 ± 0.41 |
| Fed intake (g/day) | 15.52 ± 1.30 | 14.97 ± 1.07 |
| Drink quality (ml/day) | 35.8 ± 1.1 | 27.8 ± 0.9 |
| Sperm motility | | |
| Sperm vitality (%) | 90.0 ± 0.00 | 88.3 ± 2.9 |
| Sperm concentration | 5.7 ± 1.37 | 6.9 ± 1.08 |
| (10⁸/ml) | | |
| Quantity of motion | | |
| Revolving club (sec) | 41.0 ± 1.6 | 41.5 ± 9.1 |
| Revolving basket | 18 | 17 |
| (times/10 min) | | |
| Swimming endurance | 10,481 ± 5,315 | 11,713 ± 3,519 |
| (sec) | | |
| Blood | | |
| pH | 7.66 ± 0.10 | 7.84 ± 0.09 |
| TG | 171.5 ± 39.2^{a} | 133.1 ± 33.3^{b} |
| TC | 171.1 ± 62.3 | 146.6 ± 62.1 |
| HDL | 82.8 ± 10.7 | 69.3 ± 7.4 |

*A: General cage, and water from general purifier and AIN-diet stored in general refrigerator
B: Cage with jade-containing tile, water from jade purifier, and AIN-diet stored in jade refrigerator
p < 0.05: Statistically significant at 95%

<Results>

(1) The two groups showed no difference in the parturition rate and the blood lipid concentration.

(2) While there was no considerable difference in the sperm vitality between the two groups, the sperm concentration of the jade-treated group was approximately 17% higher than that of the control group.

(3) In measurement of the sperm motility, the swimming endurance of the jade-treated group was approximately 1,200 seconds, on the average, longer than that of the control group.

(4) The pH of blood was slightly higher in the jade-treated group than in of the control group.

(5) The HDL level in blood lipid was slightly higher in the control group than in the jade-treated group.

### Experimental Example 12

As can be seen Tables 22 and 23 below, in order to investigate the effects of different kinds of drinking water on the parturition and weaning of test groups (white rats), tests were carried out on 5-week-old white rats. The drinking water was divided into three groups: underground water (A), water from a general purifier (B), and nephrite jade powder water of the present invention (C). As test feed, AIN-diet was equally fed to the test groups. 9 female white rats (♀; 3×3 repetition) were assigned to each of three groups (a total of 27 rats), and 8 male white rats (♂) were assigned to each of three test groups (a total of 24 rats). After being reared for 4 weeks, the test group rats were mated for 7 days, the mating ratio being ♂/♀=1:3. With the passage of 3 weeks of pregnancy, the test group rats were reared from parturition to weaning time.

TABLE 22
Effects of different kinds of water on white rats

| | Group* | | |
|---|---|---|---|
| | A | B | C |
| Measurement gain¹⁾ | | | |
| Daily weight gain | 4.32 ± 0.26 | 4.20 ± 0.57 | 4.33 ± 0.37 |
| (g/day) | | | |
| Feed intake (g/day) | 16.25 ± 0.32 | 16.51 ± 0.45 | 17.01 ± 1.06 |
| Drink quantity | 20.3 ± 1.2 | 22.00 ± 1.8 | 19.8 ± 1.1 |
| (ml/day) | | | |
| Sperm mobility) | | | |
| Sperm vitality (%) | 91.1 ± 2.3 | 90.5 ± 2.8 | 91.1 ± 2.8 |
| Sperm concentration | 4.01 ± 1.09 | 4.26 ± 0.71 | 4.87 ± 1.41 |
| (10⁸/ml) | | | |
| Quantity of motion | | | |
| Revolving basket | 57.8 ± 3.16 | 35.2 ± 19.0 | 33.3 ± 14.7 |
| (times/10 min) | | | |
| Swimming endurance | 4,082 ± 813 | 5,087 ± 1,471 | 5,332 ± 445 |
| (sec) | | | |
| Revolving club (sec) | 39.6 ± 18.9 | 32.9 ± 9.9 | 31.5 ± 11.0 |
| Blood pH | 7.64 ± 0.09 | 7.69 ± 0.12 | 7.78 ± 0.24 |

¹⁾Measured from male rats
*A: A: Underground water,
B: Water from general purifier, and
C: Nephrite jade powder water

TABLE 23
Effects of different kinds of water on parturition of white rats

| | | Parturition | | | |
|---|---|---|---|---|---|
| | Days from | (No. of rats) | Total | No. of | No. of |
| | mating to | parturition | No. of | pups per | weaned pups |
| Group ¹⁾ | parturition | rate %) | pups | litter | (♂/♀) |
| A | 24.2 ± 1.5 | 5(55.6) | 56 | 11.2 ± 1.9 | 53(26/27) |
| B | 25.5 ± 2.3 | 6(66.7) | 46 | 7.7 ± 2.9 | 39(17/22) |
| C | 24.7 ± 2.3 | 7(77.8) | 81 | 11.6 ± 0.5 | 69(41/28) |

<Results>

(1) There was no significant difference in growth rate, quantity of motion and sperm motility between treated groups A, B and C.

(2) The average sperm concentration of the group C was 4.87×10⁸/ml, which was 21.4% and 14.3% higher than the other two groups A and B having average sperm concentrations of 4.01×10⁸/ml and 4.26×10⁸/ml, respectively.

(3) The parturition rates were 55.6%, 66.7% and 77.8% for the underground water, the water from a general purifier and the nephrite jade powder water, respectively, indicating that the parturition rate of the jade treated group C was slightly higher.

(4) The numbers of puppies per litter were 11.2±1.9, 7.7±2.9 and 11.6±0.5 for underground water, water from a general purifier and nephrite jade powder water, respectively.

(5) The numbers of puppies which weaned 3 weeks after parturition were 53, 39 and 69 for the groups A, B and C, respectively, and the sex (♀/♂) ratios were 26/27, 17/22 and 41/28, indicating that the male pups in the group C were more than the female pups.

As can be seen in the above results, the sperm concentration of the jade-treated group was 21.4% and 14.3% higher than those of the other groups, respectively. Also, the parturition rate of the female white rats in the jade-treated group was 78% which was higher than those of the other groups having parturition rates of 56% and 67%, respectively. Furthermore, in the sex ratio of weaned puppies, the ratio of the male pups in the jade treated group was higher than those in the other groups.

### Experimental Example 13

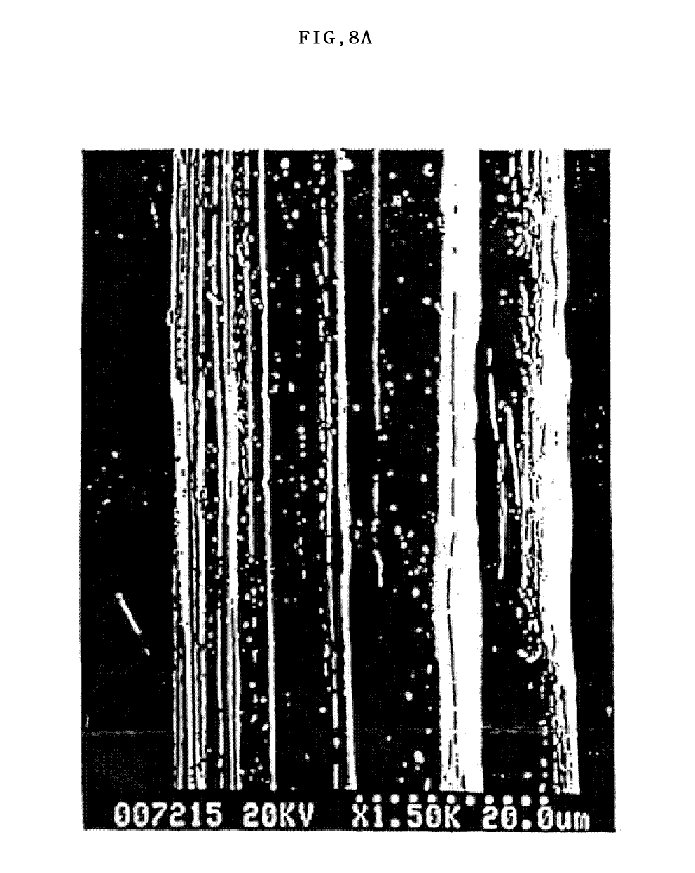

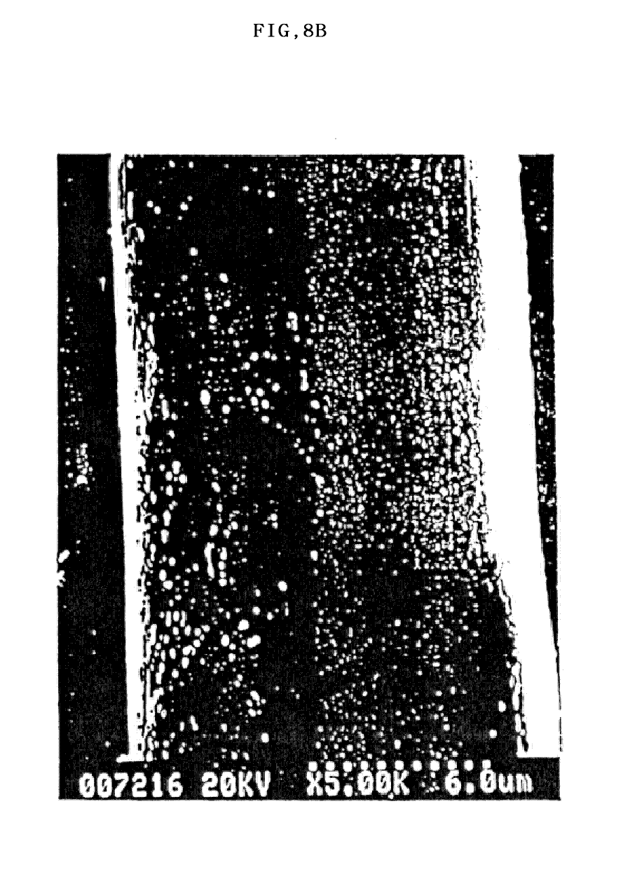

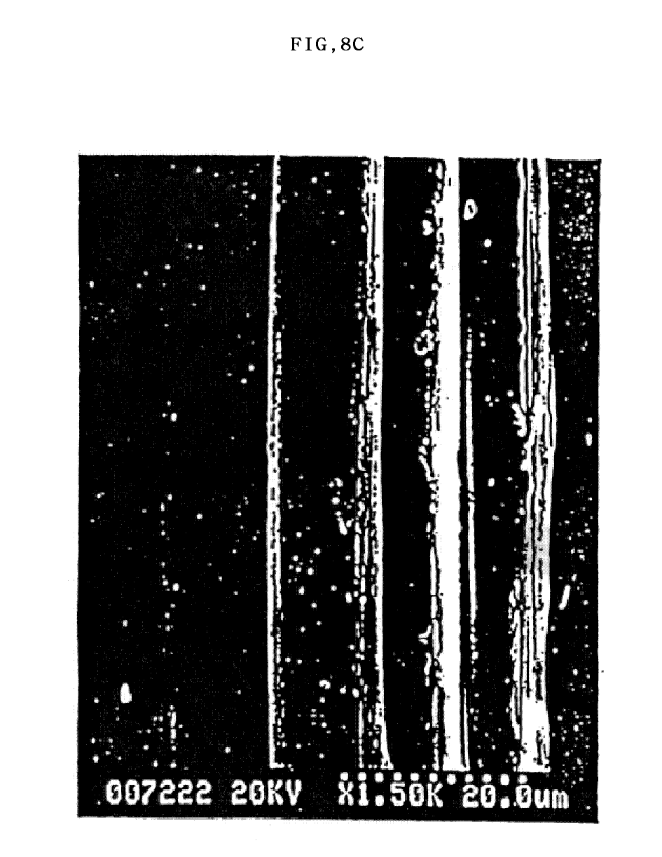

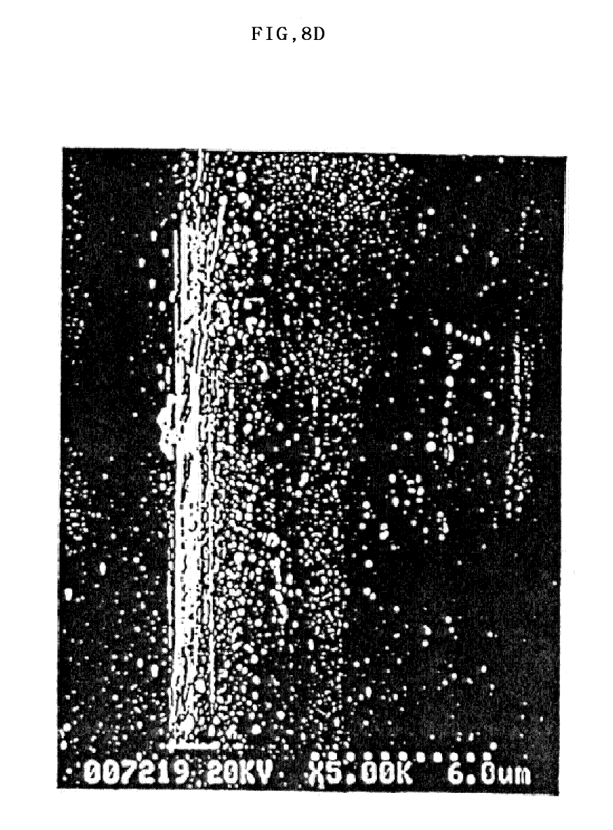

In this Experiment, tap water was purified with the filter produced in the above Example of the present invention, and the effect of the purified jade-treated water on the growth of silkworm and the quality of the produced silk (FIG. 8).

(A) Materials and Methods

1. Species of silkworm: Bombyx mori

2. Period of growth: November to December

3. Method for growth: constant temperature and constant humidity, and mulberry leaves during all instars

4. Number of silkworms:

Control group-150 (2 repetition)

Treated group-130 (2 repetition)

5. Treatment:

Control group: Feeding of mulberry leaves sprayed with distilled water.

Treated group: Feeding of mulberry leaves sprayed with jade-treated water.

Time to treat silkworms: starting from 2^{nd} instar

TABLE 24
Results of rearing performed with the jade powder water treatment

| | | | Larval | Total | | |
|---|---|---|---|---|---|---|
| | | Number of | period of the | larval | Pupation | |
| | | larvae | 5^{th} instar | period | percent | |
| | Repetition | treated | (day/hr) | (day/hr) | (%) index | |
| Control | 1 | 150 | 7/07 | 23/07 | 91.3 | 100 |
| group | 2 | 150 | 7/07 | 23/07 | 76.6 | |
| | Average | 150 | 7/07 | 23/07 | 84.0 | |
| Treated | 1 | 130 | 7/15 | 23/15 | 74.1 | 85 |
| group | 2 | 130 | 7/15 | 23/15 | 68.2 | |
| | Average | 130 | 7/15 | 23/15 | 71.2 | |

TABLE 25
Cocoon reeling with nephrite jade powder water treatment

| | Cocoon | Cocoon | | | Nonbroken | |
|---|---|---|---|---|---|---|
| | filament | filament | Silk | Nonbroken | filament | Reel- |
| | length | weight | size | length | weight | ability |
| | (m) | (cg) | (d) | (m) | (cg) | (%) |
| Control | 1,222 | 33.7 | 2.48 | 3.47 | 23.4 | 69 |
| group | | | | | | |
| Treated | 1,283 | 36.3 | 2.55 | 1,005 | 28.5 | 78 |
| group | | | | | | |

TABLE 26
Change in larval weight caused by jade treatment

| | Weight of | Weight of | Weight at | |
|---|---|---|---|---|
| | newly exuviated | newly exuviated | day 3 of | |
| | larva from | larva from | the 5^{th} | Matured |
| | the 3^{rd} molding | the 4^{th} molding | instar | larvae |
| Control | 0.46 | 1.85 | 20.80 | 47.4 |
| group | | | | |
| Treated | 0.47 | 1.94 | 23.03 | 52.2 |
| group | | | | |

TABLE 27
Effect of jade solution on decrease in blood glucose level

| | Blood glucose level | | Decrease in blood |
|---|---|---|---|
| | Injected | Injected with | glucose level |
| | with maltose¹ | silkworm extract | Decrease (C = A − |
| Silkworm | (A) | (B) | B)/efficiency |
| extracts | mg/100 ml | mg/ml | mg/ml % |
| Treated | 64.0 ± 1.87 | 27.7 ± 1.70 | 36.3/56.7 |
| with water | | | |
| Treated | 69.6 ± 1.62 | 20.7 ± 1.62 | 48.9/70.3 |
| with jade | | | |
| solution | | | |

¹Before injection with silkworm extract

<Results>

1. The weight of the larva in the jade-treated group was higher than that in the control group in every instar. In particular, in the case of the matured larva, the weight of each larva in the jade-treated group was higher by 0.48 g than that in the control group.

2. The pupation percentage of the jade-treated group was 71.2%, which was lower by about 15% than that of the control group. The cocoon yield of the jade-treated group was 15.4 g per 10,000 larvae, which was lower by 7% than that of the control group.

3. The single cocoon weight of the jade-treated group was 2.14 g, which was higher by about 6% than that of the control group. Also, the cocoon shell weight of the jade-treated group was 44.5 cg. The cocoon shell percentage of the jade-treated group was higher by 2% than that of the control group.

4. The reeling performance of the jade-treated group was generally better than that of the control group. In particular, the jade-treated group was excellent with respect to the cocoon filament length, cocoon filament weight and reelability (higher by about 9% than that of the control group).

5. With respect to silk quality, the fineness of the jade-treated group was slightly thicker than that of the control group. Also, the tenacity, elongation and raw silk percentage of the jade-treated group were higher than those of the control group. However, the cocoon yield of 10,000 larvae in the jade-treated group was lower than that of the control group.

6. No substantial difference in the surface structure between the control group and the jade-treated group was observed.

7. The crystalline structure of the treated jade had a rod shape having a sharp tip.

### Experimental Example 14

The test cup prepared in Example of the present invention and a control cup made of polyethylene were filled with homogenized Grade-A milk, and allowed to stand for 48 hours at ambient temperature. Then, the milk was analyzed. The analysis results are shown in Table 28 below.

TABLE 28

| Kind of | | |
|---|---|---|
| microorganisms | Control cup | Test cup |
| E. coli | No/ml | No/ml |
| Lactobacillus | 45000 cfu/ml | 37000 cfu/ml |
| Yeast and mold | 310 cfu/ml | 280 cfu/ml |
| General | More than 3 × 10⁶ | More than 3 × 10⁶ |
| microorganisms | cfu/ml | cfu/ml |

Conclusion: The number of microorganisms harmful to the human body was reduced.

### Experimental Example 15

In this experimental example, a test for the food decomposition rate of the synthetic resin rice-bowl prepared in Example of the present invention was performed as shown in Table 29 below.

TABLE 29

| | |
|---|---|
| Sample | Jade bowl |
| Appearance | Milk white |
| Experimental method | Described below |
| Results | Shown in Table 30 |

Experimental method: Five jade bowls (test group) and five general bowls (control group) were filled with a 1:1 mixture of boiled rice and sterile water and allowed to stand at room temperature for 24 hours. The lids of the bowls were removed such that the content of the bowls was completely exposed to air, and the two groups were spaced approximately 1 meter apart from each other. At the time points shown in Table 30 below, a standard plate count was performed.

TABLE 30
unit: cfu/ml

| | | |
|---|---|---|
| Bowl | Control group | Test group |

0 hr

| | | |
|---|---|---|
| #1 | 0.0 | 0.0 |
| #2 | 0.0 | 0.0 |
| #3 | 0.0 | 0.0 |
| #4 | 0.0 | 0.0 |
| #5 | 0.0 | 0.0 |

18 hrs

| | | |
|---|---|---|
| #1 | 721.635 | 666.690 |
| #2 | 516.608 | 522.620 |
| #3 | 629.715 | 570.620 |
| #4 | 777.595 | 707.724 |
| #5 | 737.701 | 731.678 |

24 hrs

| | | |
|---|---|---|
| #1 | 1036.981 | 1005.890 |
| #2 | 1210.1281 | 1060.1095 |
| #3 | 1068.889 | 951.180 |
| #4 | 972.1050 | 1002.971 |
| #5 | 1042.1160 | 978.1149 |

Conclusion: In the decomposition of food in the test group bowls and the control group bowls, the food decomposition rates of the test group bowls were lower than those of the control group bowls, suggesting that the jade bowls of the present invention had advantageous effects on food storage.

### Experimental Example 16

In this experiment, the effect of nephrite jade powder of the present invention on the freshness of pork was examined as shown in Table 31 below.

TABLE 31
Effect of nephrite jade bowl on the freshness of pork

| | | | Temperature (° C.) | | | |
|---|---|---|---|---|---|---|
| | | | 0 | | 4 | |
| Bowl | | | Control group | Nephrite jade | Control group | Nephrite jade |
| Day | 0 | pH | 5.83 ± 0.04 | | | |
| | | VBN | 3.50 ± 0.43 | | | |
| | | TBA | 0.063 ± 0.013 | | | |
| | | color(ΔE) | 53.70 ± 4.34 | | | |
| Day | 4 | Drip loss(%) | 0.14 | 0.57 | 0.54 | 0.01 |
| | | pH | 5.46 ± 0.04 | 5.42 ± 0.00 | 5.59 ± 0.01 | 5.69 ± 0.01 |
| | | VBN | 5.56 ± 0.20 | 4.29 ± 0.20 | 5.65 ± 0.39 | 5.42 ± 1.41 |
| | | TBA | 0.153 ± 0.00 | 0.104 ± 0.032 | 0.122 ± 0.006 | 0.099 ± 0.025 |
| | | Color(ΔE) | 55.80 ± 0.01 | 49.30 ± 0.11 | 54.90 ± 0.08 | 56.50 ± 0.07 |
| DAY | 7 | Drip loss(%) | 1.02 | 0.17 | 1.90 | 0.43 |
| | | pH | 5.77 ± 0.03 | 5.84 ± 0.01 | 5.56 ± 0.01 | 5.65 ± 0.01 |
| | | VBN | 2.36 ± 0.00 | 2.32 ± 0.00 | 3.48 ± 0.45 | 2.59 ± 0.22 |
| | | TBA | 0.234 ± 0.013 | 0.203 ± 0.006 | 0.239 ± 0.006 | 0.203 ± 0.019 |
| | | Color(ΔE) | 55.50 ± 0.47 | 52.60 ± 0.75 | 52.80 ± 0.06 | 52.90 ± 0.05 |
| DAY | 14 | Drip loss(%) | 0.92 | 0.27 | 2.70 | 0.19 |
| | | pH | 5.50 ± 0.01 | 5.67 ± 0.03 | 6.71 ± 0.00 | 5.91 ± 0.02 |
| | | VBN | 3.00 ± 0.39 | 3.98 ± 0.18 | 6.17 ± 0.87 | 3.85 ± 0.53 |
| | | TBA | 0.162 ± 0.013 | 0.176 ± 0.019 | 2.406 ± 0.191 | 0.811 ± 0.089 |
| | | Color(ΔE) | 51.70 ± 0.10 | 53.80 ± 0.13 | 62.80 ± 0.00 | 56.70 ± 0.04 |
| DAY | 21 | Drip loss(%) | 1.11 | 0.35 | 0.85 | 0.25 |
| | | pH | 6.41 ± 0.01 | 6.07 ± 0.00 | 7.24 ± 0.00 | 6.69 ± 0.01 |
| | | VBN | 5.32 ± 0.36 | 7.35 ± 0.42 | 30.67 ± 3.31 | 15.08 ± 0.98 |
| | | TBA | 10.220 ± 0.230 | 6.852 ± 0.274 | 10.15 ± 0.198 | 2.298 ± 0.102 |
| | | Color(ΔE) | 52.40 ± 0.06 | 59.20 ± 0.13 | 58.20 ± 0.13 | 66.30 ± 0.33 |

Drip Loss: %
VBN: mg %
TBN: mg Mal/kg of meat
Color: meat color

Drip Loss: %

VBN: mg %

TBN: mg Mal/kg of meat

Color: meat color

The above experiment was performed to investigate the effect of nephrite jade on the change in freshness of pork with time when the pork was stored in the bowl prepared in the present invention. Pork was stored either in the nephrite jade bowl or in the general bowl (control) for 0, 4, 7, 14 or 21 days at 0° C. or 4° C. 100 g of the ham portion cut from pork was stored in each bowl, while the drip loss, meat color, pH, volatile basic nitrogen (VBN) and lipid oxidation (TBA) of the ham portion were measured.

### <Results>

(1) When pork was stored in the nephrite jade bowl, the drip loss with the passage of time was much lower than in the general bowl regardless of the storage temperature.

(2) As an important indicator of postmortem change of muscles, the pH was higher at 4° C. that at 0° C., but there was a distinct difference in pH between the two bowl groups.

(3) The VBN value indicating the degree of protein denaturation was slightly high at 0° C. at day 14 and day 21, but it was clearly low in the nephrite jade bowl at 4° C. with the passage of time.

(4) The TBA value indicating the degree of lipid oxidation was much lower in the nephrite jade bowl regardless of the storage temperature.

### Experimental Example 17

The experiment was carried out to examine the effects of the nephrite jade mug prepared in Example of the present invention the taste attributes of coffee when the jade mug was used to drink the coffee. The experiment was performed by the Department of Food & Nutrition of Chung-Ang University and the Korea Food Research Institute. The details are described below.

1. Objective of the Experiment

To examine if there is any change in taste, aroma, aftertaste or color of coffee when the nephrite jade mug or a plain mug are used to drink the coffee.

2. Sensory Test Method: Paired Preference Test
To test preference of one sample over another sample
Evaluation items: taste, aroma, aftertaste and color.

3. Sensory Panel
20 to 25 students in the fifth grade of the Food and Nutrition Department of Chung-Ang University, South Korea (who have experience in a sensory test and have knowledge on the test method).

4. Sensory Test Period
March to June, 1990
Once a week
A total of 10 times

5. Test Cup and Type of Beverage
Nephrite cup and plain cup having the same appearance.
Type of beverage: instant coffee

6. Preparation of Samples
One tea spoon of coffee was put in each cup, and water boiled to 100° C. was added so as to fill 1/2 of each cup.

7. Statistical Processing:
T-test (p≦0.05)

### <Results>

1. Taste: the taste of coffee contained in the nephrite jade mug was much milder than that in the plain mug (p≦0.05).

2. Color and aftertaste: the color and aftertaste of coffee in the nephrite jade mug were more preferred, but there was no statistical significance between the nephrite jade mug and the plain mug.

3. Aroma: the plain mug gave a better coffee aroma than the jade mug, but there was no statistical significance between the nephrite jade mug and the plain mug.

### CONCLUSION

The nephrite jade mug showed the effect of making the taste of coffee mild, and this effect was statistically significant. Meanwhile, the aftertaste and color of coffee contained in the nephrite jade mug were similar to or better than those in the plain mug, but were not statistically significant.

TABLE 32
Primary skin irritation test

| | |
|---|---|
| Sample | Jade powder |
| Appearance | White powder |
| Experimental method | Described below |
| Results | Described below |

Methods: Federal Register, Vol. 43, No. 163
CTFA (The Cosmetic, Toiletry and Fragrance Association, Washington, D.C.) Technical Guideline Procedure

Experimental procedure: A patch test technique was used on the abraded skin and intact skin of a white rabbit.

The hair was clipped from the back and flanks. Two areas of the back, spaced approximately 10 cm apart from each other, were designated for the position of the patches. One area was abraded by making 4 minor epidermal incisions in the area of the patch (2 incisions were perpendicular to the other in a “tic-tac-toe pattern”). The 1-inch square patches of surgical gauze were secured in place using thin rubber bands and adhesive tapes. The sample was introduced under the patch at each site in an amount of 0.5 ml (g). The entire trunk of the animal was then wrapped with rubberized cloth for the 24-hour period of exposure. The animals were restrained during the exposure period. After removal of the patches, reactions occurring at each site were evaluated based on the following criteria. The evaluation results are shown in Table 33 below.

### Evaluation of Skin Reactions

Erythema and Eschar Formation

No erythema—0

Very slight erythema (barely perceptible)—1

Well defined erythema—2

Moderate to severe erythema—3

Severe erythema (beet redness) to slight eschar formation (injuries in depth)—4

Edema Formation

No edema—0

Very slight edema (barely perceptible)—1

Slight edema (edges of area well defined by raising)—2

Moderate edema (raised approximately 1 mm)—3

TABLE 33

| | 24 hrs | | | | 72 hrs | | | |
|---|---|---|---|---|---|---|---|---|
| | Intact | | Abraded | | Intact | | Abraded | |
| | skin | | skin | | skin | | skin | |
| Rabbit | ER | ED | ER | ED | ER | ED | ER | ED |
| #1 | 0 | 0 | 0 | 0 | 0 | 0 | 0 | 0 |
| #2 | 0 | 0 | 0 | 0 | 0 | 0 | 0 | 0 |
| #3 | 0 | 0 | 0 | 0 | 0 | 0 | 0 | 0 |
| #4 | 0 | 0 | 0 | 0 | 0 | 0 | 0 | 0 |
| #5 | 0 | 0 | 0 | 0 | 0 | 0 | 0 | 0 |
| #6 | 0 | 0 | 0 | 0 | 0 | 0 | 0 | 0 |

Conclusion: The sample causes no irritation to the skin, and thus is suitable for use in skin cosmetic products.

TABLE 34
Acute oral toxicity (0.5 g/100 g weight) test

| | |
|---|---|
| Sample | Nephrite jade powder |
| Appearance | White powder |
| Experimental method | Described below |
| Results | Shown in Table 24 |

TABLE 35

| | | Initial | | Later | |
|---|---|---|---|---|---|
| | | weight | Dose | weight | |
| Rat | Sex | (g) | (ml) | (g) | Toxicity |
| 1 | F | 207 | 1.0 | 219 | No |
| 2 | F | 211 | 1.1 | 226 | No |
| 3 | F | 215 | 1.1 | 225 | No |
| 4 | F | 208 | 1.0 | 217 | No |
| 5 | F | 200 | 1.0 | 213 | No |
| 6 | M | 227 | 1.1 | 235 | No |
| 7 | M | 216 | 1.1 | 224 | No |
| 8 | M | 205 | 1.0 | 218 | No |
| 9 | M | 210 | 1.1 | 224 | No |
| 10 | M | 212 | 1.1 | 221 | No |

Preparation of sample: The sample was added to sterile distilled water and extracted by boiling for 10 minutes, and the extract was administered through a cannula in an amount of 0.5 g per 100 g weight of the animal.

Conclusion: The sample showed no oral toxicity.

### Experimental Example 18

To investigate various influences of nephrite jade powder used in the present invention on the human body, an experiment was performed at Biological Information System Engineering Laboratory, Inha University, South Korea. As 70% of the human body consists of water, there may be many relationships between the change of water and influences on human body. Therefore, the effects of nephrite jade powder on hard water were examined, and then the effects of nephrite jade powder on the proliferation of Digitalis plant cells were examined.

A. Change of Hard Change

### <Experiment 1>

50 ml of artificially made hard water (hardness: 100 ppm) was put in each of 4 flasks, and nephrite jade was placed on the bottom of two of these flasks for 10 minutes.

To examine the change in hardness, a titration method that uses ethylene diamine acetic acid (hereinafter referred to as “EDTA”; factor: 2.9412) was used. 1 ml of buffer solution (pH 10) and EBT as an indicator were used.

The change of hardness was measured by the amount of EDTA used until the color of hard water was changed by EDTA. At this time, the color would be restored to the original color with the passage of time passes, but in this experiment, the measurement was done when the color changed.

### <Result 1>

For hard water of 100 ppm, 1.70 ml of EDTA was consumed.

After hard water has been treated with nephrite jade, 1.25 ml of EDTA was consumed. Thus, the hardness of hard water was reduced from 100.00 ppm to 73.53 ppm by nephrite jade. Namely, nephrite jade reduced a hardness of 100.00 ppm by 26.47%.

### <Experiment 2>

200 ml of hard water (hardness: 100 ppm) prepared in Experiment 1 was put in a beaker, and nephrite jade was immersed in the beaker. After 30 minutes, water contained in the beaker was divided into 3 flasks, and the change of hardness of the water was changed. In this experiment, even after the color of hard water changed, EDTA was dropped for a more precise measurement until the color of hard water no longer changed, and the hardness at that point was measured.

### <Result 2>

After treatment with nephrite jade, the hard water samples of 100 ppm in the three flasks were reduced to 89.62 ppm, 91.19 ppm, and 89.62 ppm, respectively, which averaged 90.14 ppm. Thus, nephrite jade reduced the hardness of hard water by 9.9%.

### <Experiment 3>

This experiment was performed with ordinary tap water. Tap water contained in a vessel was transferred into flasks, and nephrite jade was placed on the bottom of 3 flasks among the 6 flasks. After about 5 minutes, the hardness of the tap water was measured.

### <Result 3>

Tap water not treated with nephrite jade: 97.48 ppm, 97.48 ppm, and 97.48 ppm. Average: 97.48 ppm.

Tap water treated with nephrite jade: 91.19 ppm, 91.19 ppm, and 91.19 ppm. Average: 91.19 ppm.

Thus, nephrite jade reduced the hardness of hard water by 6.5%.

B. Effect of nephrite jade on the proliferation of Digitalis lanata suspension cells

(1) Effect of Nephrite Jade on the Growth of Digitalis Lanata Cells in Growth Medium

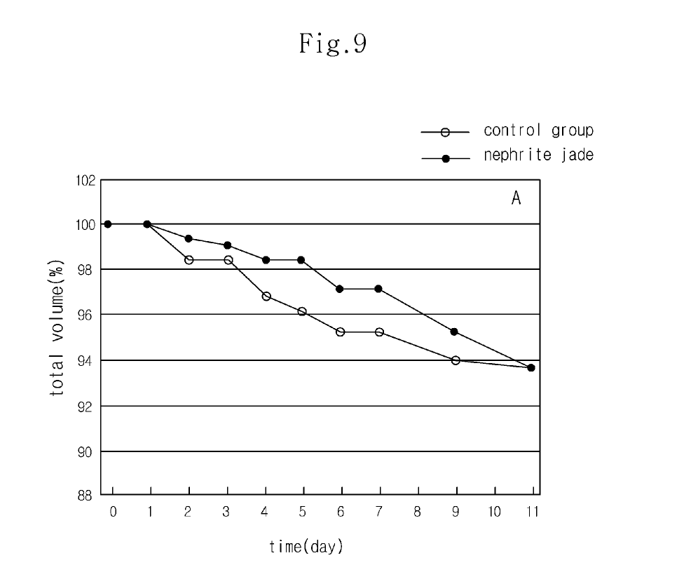

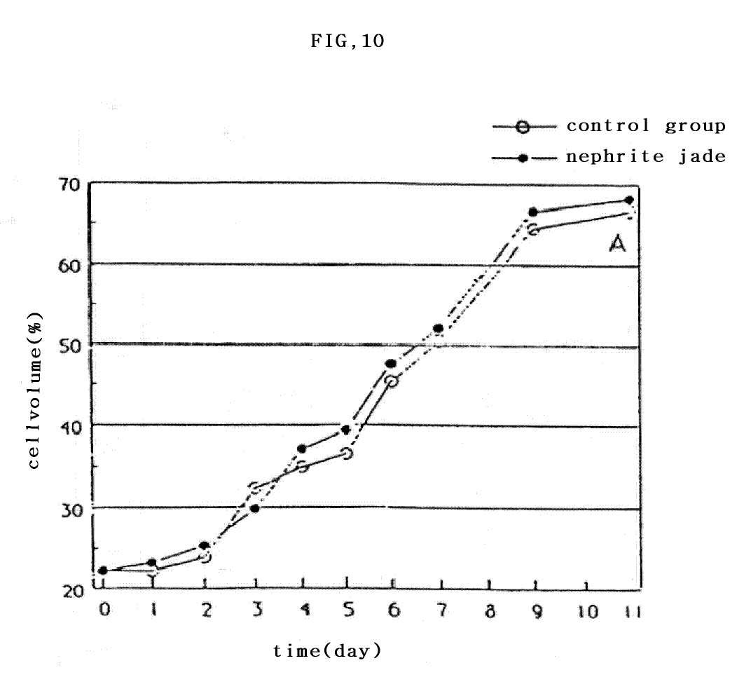

FIG. 9 is a graph showing the change in total volume of a culture of Digitalis lanata cells proliferating in growth medium, observed for 11 days, and FIG. 10 is a graph showing the change in volume of Digitalis lanata cells. Since the depletion of medium components and the evaporation of medium occur in proportion to an increase in the number of growing cells with the passage of time, the change in total volume of the culture reflects these factors. Specifically, the humidity and temperature of air have a close relationship with the evaporation of medium, and these factors also influence the growth rate of cells.

As shown in the drawings, in the case in which nephrite jade was used, the total volume of the culture was reduced little by little compared to that in the control group in which no nephrite jade was used. This is because the use of nephrite jade showed a cell growth rate higher than the control group so as to overcome the evaporation of medium or the depletion of medium nutrients, such that rapid depletion of the medium could be somewhat offset. As shown FIG. 10 showing the results obtained by measuring the change in volume of only precipitated cells, the case in which nephrite jade was used continuously during a period ranging from day 4 to day 11 after inoculation showed a great increase in the cell volume compared to the control group in which no nephrite jade was used. Thus, the case in which nephrite jade was used showed a high cell growth rate compared to the control group in which no nephrite jade was used. It can be considered that such a high cell growth rate could offset the reduction in total volume of the cell culture, caused by the depletion of nutrients and the evaporation of medium, thus delaying the rate of reduction in the total volume compared to the control group. Also, when comparing the increased volume of the cells, it was observed that the cell volume showed a tendency to increase gradually after 4 days. This tendency is believed to support the above-described results. Generally, growth curves of all cells are indicated by an S-shaped curve which can be divided into 4 phases: a lag phase wherein cells adapt to medium and there is no proliferation of cells and no increase in the mass of cells; an exponential phase wherein the mass of cells rapidly increase due to a rapid proliferation rate, thus showing a curve having a steep gradient; a stationary phase wherein the cell growth reaches the maximum and the increase in mass of cells no longer appears; and a dead phase wherein the total volume or mass of cells decreases due to the depletion of nutrients, the release of toxic components and the saturation of cells, leading to the death of cells.

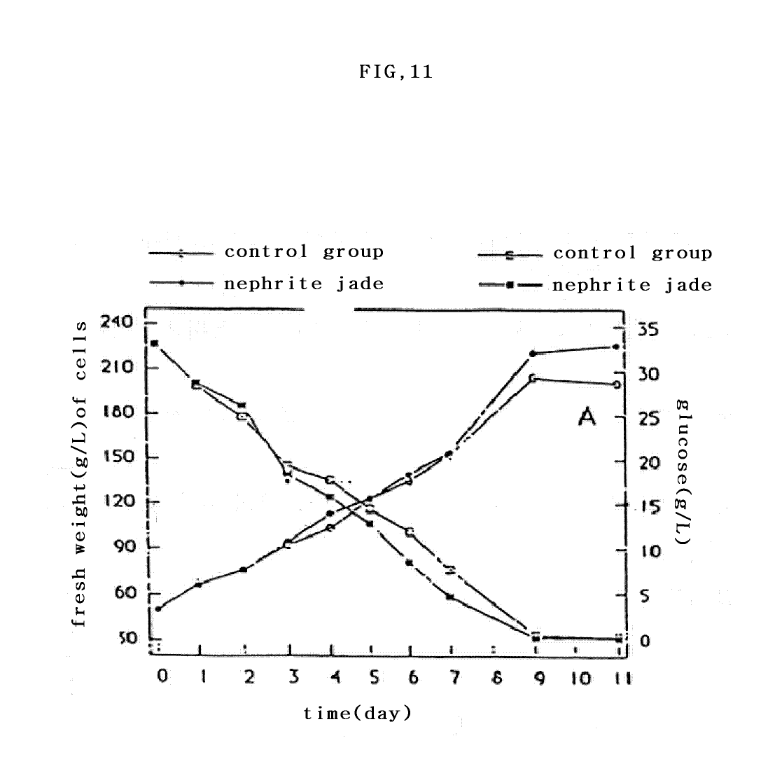

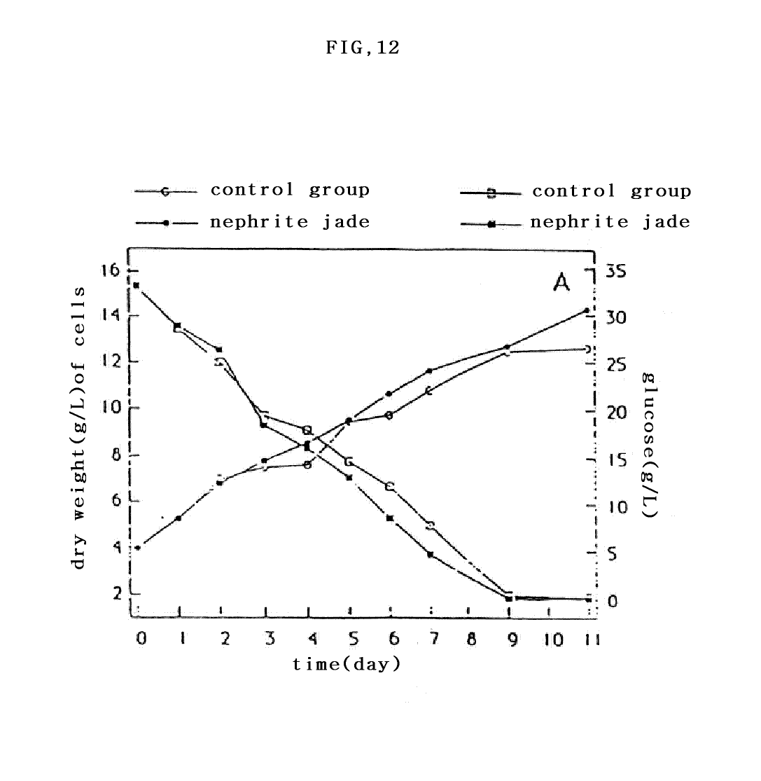

FIGS. 11 and 12 show the results of measuring the fresh weight and dry weight of cells.

FIG. 11 follows the 4-phase growth curve. After day 7, the group in which nephrite jade is used shows a proliferation rate slightly higher than the control group in which no nephrite jade is used, and then the nephrite jade group continues to proliferate till day 10 or later, unlike the control group in which the cell proliferation stops to reduce the fresh weight of cells. It is noteworthy that the nephrite jade group shows continuous cell growth even at the time point at which the concentration of glucose (a nutrient acting as a main metabolic substrate in medium) in medium becomes zero. Generally, at the time point at which nutrients are depleted, the cells stop to proliferate and the growth rate shows a tendency to decrease, like the case of the control group in which no nephrite jade is used. However, in the case in which nephrite jade is used shows phenomena different from those of the control group, suggesting that nephrite jade influences the growth of cells. Such results are also shown in FIG. 12. As can be seen therein, after day 3, the nephrite jade group showed a high cell growth rate compared to the control group, and after day 9, showed the phenomena shown in FIG. 11. Therefore, the cells cultured in growth medium close to nephrite jade show good effects on cell growth compared to the control group. When Digitalis lanata plant cells showing a growth limit of about 10 days were cultured using nephrite jade, the cells maintained a stable state for at least 10 days without causing necrosis, even when the medium was not replaced by fresh medium, and the cells showed a tendency to proliferate even after 10 days. For these reasons, it is expected that nephrite jade can be advantageously used to optimize the growth and concentration of cells in a process for producing useful substances.

(2) Effect of Nephrite Jade on the Change in pH of Medium

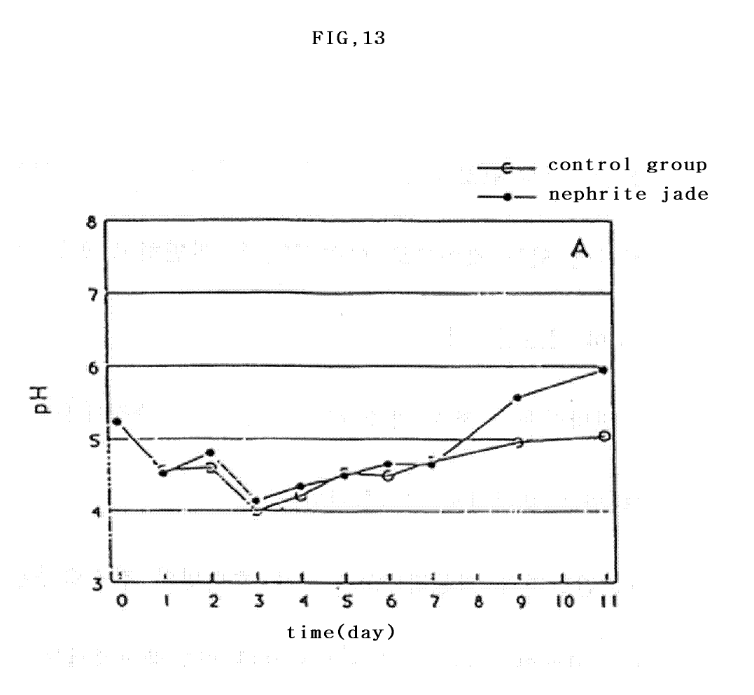

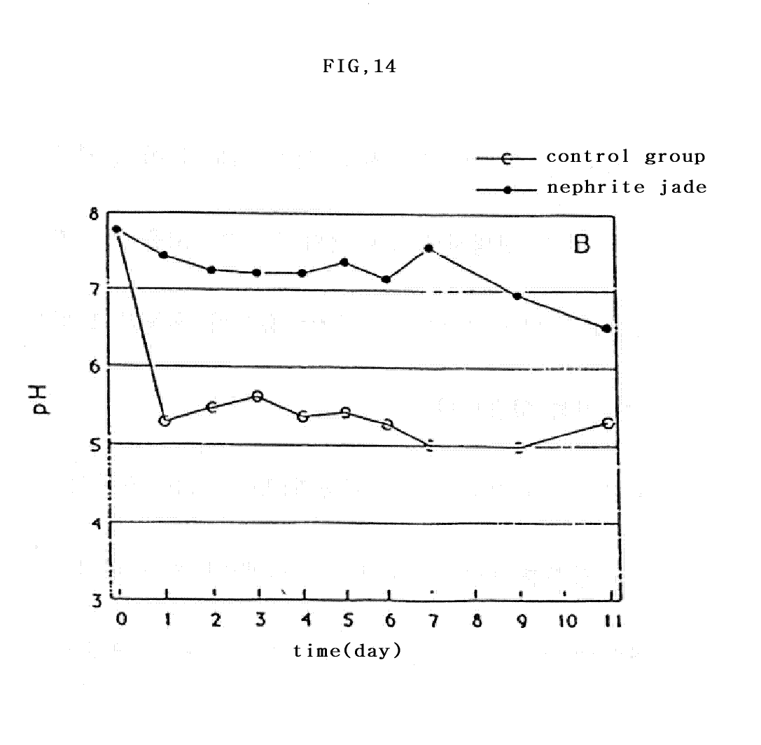

FIG. 13 is a graph showing the change in pH of cell culture medium, and FIG. 14 is a graph showing the change in pH of culture medium after adding nephrite jade powder.

FIG. 13 showing the results of measuring the change in pH in the case in which nephrite jade was used in growth medium and the control group in which no nephrite jade was used. In the control group, the pH change occurring in the medium applied to general plant cells appeared, wherein the pH decreased gradually with time, and then was kept at a certain level. However, in the case in which nephrite jade was used, the pH change was similar to that of the control group till 7 days, and then increased little by little. Such a phenomenon is clearly confirmed in FIG. 14 showing the results obtained by adding nephrite jade powder directly to a cell culture. As can be seen in FIG. 14, in the control group in which no nephrite jade powder was added, the pH continuously decreased, whereas, in the case in which nephrite jade powder was added, the pH was somewhat maintained. This is believed to be attributable to an ion reaction caused by mineral components contained in nephrite jade.

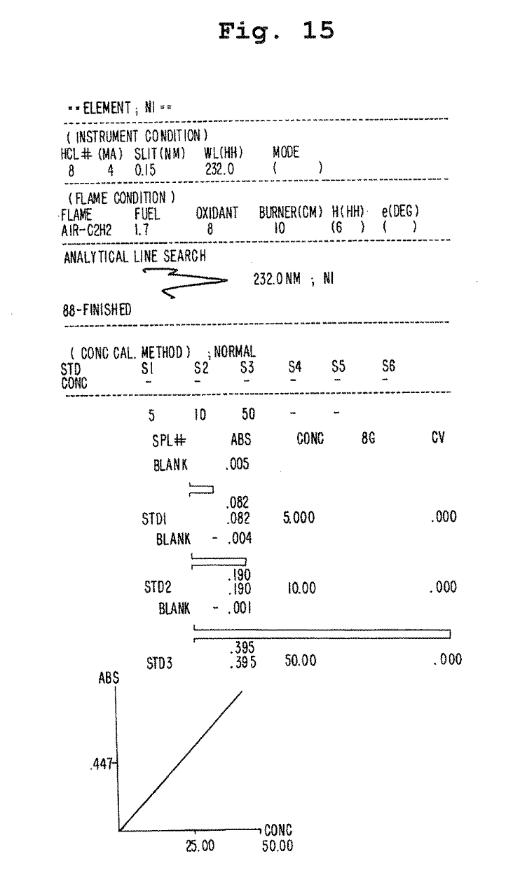

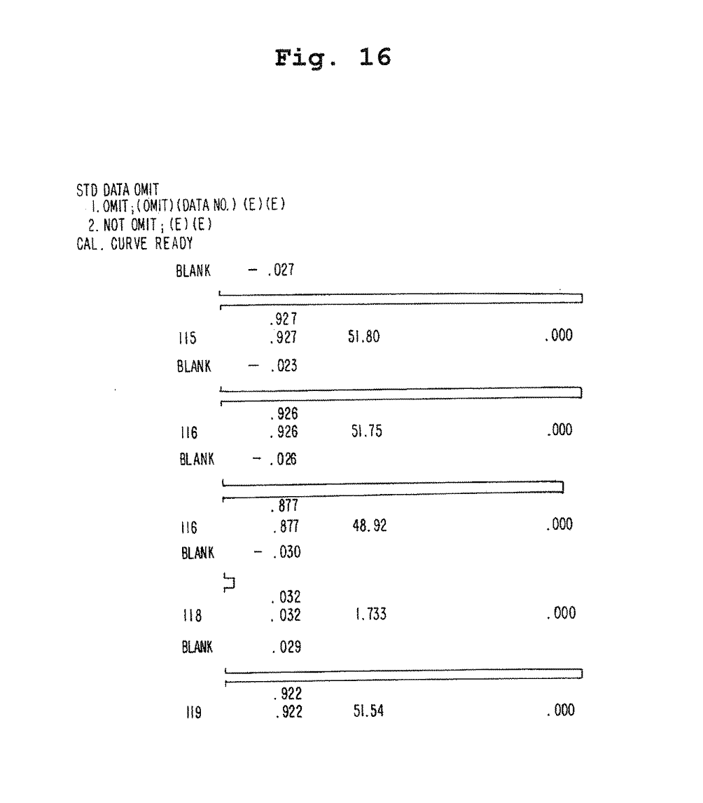

FIG. 15 shows the condition of a water quality analyzer containing nephrite jade powder of the present invention, and FIG. 16 shows the results of analysis of water containing nephrite jade powder of the present invention. The data shown in FIGS. 15 and 16 are arranged to each sample and shown in Tables 36 to 39 below. Table 36 shows the results of measuring each analysis item for sample 1 at 48 hours after adding 20 g of a nephrite jade mass to a solution. In Table 36, little or no effect of nephrite jade is shown, because there is no change in each measurement item.

Table 37 shows the results of measuring each analysis item for sample 2 at 48 hours after adding 20 g of a nephrite jade mass to a solution. In this experiment, there is little or no change in each analysis item.

Table 39 shows the results of measuring each analysis item for sample 4 at 48 hours after adding 20 g of a nephrite jade mass to a solution. In this experiment, there is little or no change in each analysis item.

Table 37 shows the results of measuring each analysis item for sample 3 at 48 hours after adding 20 g of a nephrite jade mass to a solution. However, in this experiment, many changes appeared, and these changes are as follows.

The amounts of Cr, Pb, Ni and Co, which are harmful to the human body, were greatly changed after 48 hours. The amount of Cr was 45.30 mg before the addition of nephrite jade powder, and became zero after the addition of nephrite jade. Also, Pb was completely removed from 13.76 mg to zero. The amount of Ni decreased from 51.8 mg to 1.733 mg, and the amount of Co also decreased from 52.69 mg to 11.94 mg. The amount of Mg, an element essential for the human body, increased from 48.36 mg to 55.74 mg, and this increase was attributable to binding to the component of nephrite jade, but there was no change in hardness.

The hydrogen ion concentration (pH) of the distilled water was 3.5 (acidic), but changed to 6.8 (neutral) after addition of nephrite jade, and the conductivity of the distilled water rapidly changed after addition of nephrite jade. The adsorption power of nephrite jade was about 3-4 mmol. q (equivalent) per g, which is physically great.

TABLE 36
Results of analysis before and after the reaction in solution
(sample 1: nephrite jade mass (20 g) in solution)

| | Before | After reaction | |
|---|---|---|---|
| Item | reaction | (48 hr) | Change |
| pH | 3.5 | 3.82 | — |
| Ni | 51.8 mg | 51.75 mg | — |
| Co | 52.69 mg | 52.54 mg | — |
| Cr | 45.30 mg | 43.88 mg | — |
| Mg | 48.36 mg | 48.59 mg | — |
| Pb | 13.76 mg | 13.90 mg | — |

TABLE 37
Results of analysis in case in which nephrite jade mass was placed out
of solution (Sample 2: nephrite jade mass (20 g) out of solution)

| | Before | After reaction | |
|---|---|---|---|
| Item | reaction | (48 hr) | Change |
| pH | 3.5 | 3.65 | — |
| Ni | 51.8 mg | 48.92 mg | — |
| Co | 52.69 mg | 49.83 mg | — |
| Cr | 45.30 mg | 41.23 mg | — |
| Mg | 48.36 mg | 47.97 mg | — |
| Pb | 13.76 mg | 15.1 mg | — |

TABLE 38
Results of analysis in which nephrite jade mass was added to
solution (sample 3: nephrite jade powder (20 g) in solution)

| | Before | After reaction | |
|---|---|---|---|
| Item | reaction | (48 hr) | Change |
| pH | 3.5 | 6.8 | +3.3 |
| Ni | 51.8 mg | 1.733 mg | −50.06 mg |
| Co | 52.69 mg | 11.94 mg | −40.75 mg |
| Cr | 45.30 mg | 0 mg | −45.30 mg |
| Mg | 48.36 mg | 55.74 mg | +7.38 mg |
| Pb | 13.76 mg | 0 mg | −13.76 mg |

TABLE 39
Results of analysis in which nephrite jade power was placed
out of solution (nephrite jade powder (20 g) out of solution)

| | Before | After reaction | |
|---|---|---|---|
| Item | reaction | (48 hr) | Change |
| pH | 3.5 | 3.7 | — |
| Ni | 51.8 mg | 51.53 mg | — |
| Co | 52.69 mg | 52.55 mg | — |
| Cr | 45.30 mg | 43.0 mg | — |
| Mg | 48.36 mg | 48.39 mg | — |
| Pb | 13.76 mg | 14.29 g | — |

As described above, the proliferation of Digitalis lanata plant suspension cells which have been cultured for a week near nephrite jade was increased by at least about 30% as compared to the same cell culture without nephrite jade. The obtained result is a very good proliferation result which is rare even in various experiments which have been carried out for the high-concentration culture of Digitalis lanata plant cells. In addition, in the experiment carried out to examine the effect of nephrite jade on the change of hard water, it could be seen that nephrite jade could soften hard water even without contacting nephrite jade with water. In particular, in the experiments in which the components of distilled water were analyzed 48 hours after precipitation of nephrite jade powder in the distilled water, specific phenomena, including an increase in pH, a decrease in Ni and Co, removal of heavy metals such as Cr, Pb, and an increase in Mg, were observed.

Although the effect of nephrite jade used in the present invention has not yet been clarified theoretically, it is believed that the effects changing the hardness of hard water without coming into contact with water, increasing the proliferation of Digitalis lanata plant suspension cell by at least 30%, and reducing Ni and Co, and removing heavy metals such as Cr and Pb harmful to the human body are attributable to the emission of electromagnetic waves and the ionic reactions of mineral components contained in nephrite jade.

The following experiments (Experimental Examples 19 to 23) were performed to examine the effects of nephrite jade (collected in Chuncheon, South Korea) and jade water prepared therefrom on the germination and growth of seeds.

A. Analysis of Components of Nephrite Jade and Jade Water

The components of nephrite jade collected in Chuncheon, South Korea (Hereinafter referred to “Chuncheon nephrite jade”) were analyzed using a PW 1,480×RIW-Fluorescence Seguenflal Spectrometer. The analysis results showed that the nephrite jade contained SiO₂ as a main component and some trace elements necessary for the growth of plants.

B. Analysis of Quality of Jade Water and Underground Water

The quality of jade water (underground water of a jade mine) and underground water was analyzed. The analysis results showed that no special trace elements were found in the underground water of a jade mine, i.e., jade water.

### Experimental Example 19

Effect of Jade Water on the Germination of Seeds

(1) In a germination experiment, 20 strong seeds selected from the seeds of balsam, bean, rice, radish and crown daisy were placed on 8 sheets of toilet paper laid on a Schale (laboratory dish), and then jade water, underground water and tap water were supplied thereto

(2) Seeds supplied with jade water and those supplied with tap water were spaced 50 m apart and stored in a dark place at room temperature for 5 days, and the germination rate was observed five times.

(3) To investigate the range in which the effect of jade water acts, one Schale having 20 seeds of each of radish and rice was supplied with supernatant jade water, and the remaining Schales were placed apart therefrom by 10 m, 20 m, 30 m, 40 m and 50 m and were supplied with underground water.

The experimental results are shown in Tables 40 and 41 below.

TABLE 40
Comparison of germination rates between jade
water, underground water and tap water

| | Supernatant | | | | Underground | | | | | | | | |
|---|---|---|---|---|---|---|---|---|---|---|---|---|---|
| Name | jade water | | | | water | | | | Tap water | | | | Re- |
| of seed | 2 | 3 | 4 | 5 | 2 | 3 | 4 | 5 | 2 | 3 | 4 | 5 | mark |
| Rice | 10 | 45 | 85 | 96 | 6 | 43 | 76 | 91 | 4 | 42 | 74 | 90 | |
| Radish | 27 | 78 | 90 | 96 | 26 | 73 | 87 | 94 | 24 | 72 | 86 | 94 | |
| Crown | 20 | 46 | 64 | 64 | 18 | 45 | 60 | 61 | 18 | 41 | 61 | 62 | |
| daisy | | | | | | | | | | | | | |
| Pea | 9 | 23 | 48 | 51 | 9 | 21 | 47 | 51 | 8 | 20 | 43 | 52 | |
| Chinese | 28 | 79 | 91 | 91 | 24 | 73 | 90 | 90 | 23 | 71 | 90 | 90 | |
| cabbage | | | | | | | | | | | | | |

The above results suggest that jade water promotes the germination of the five kinds of seeds.

TABLE 41
Comparison of germination rate of radish seeds
between jade water and underground water

| | Jade water | 10 m | 20 m | 30 m | 40 m | 50 m | Remarks |
|---|---|---|---|---|---|---|---|
| 1 day | 8 | 7 | 8 | 5 | 6 | 6 | |
| 2 days | 27 | 28 | 29 | 22 | 21 | 22 | |
| 3 days | 78 | 79 | 77 | 75 | 74 | 73 | |
| 4 days | 90 | 89 | 89 | 90 | 89 | 89 | |
| 5 days | 96 | 95 | 94 | 93 | 94 | 93 | |

The results suggest that the aura of jade water is exerted over approximately 20 m and promotes the germination of seeds.

### Experimental Example 20

Comparison of Effects of the Aura of Jade Porcelain on Germination of Seeds

In this experiment, 20 strong seeds of balsam, bean, rice, radish and crown daisy, were selected, 8 sheets of toilet paper were laid on 5 jade porcelain and 25 Schales to place seeds thereon to be spaced apart by 10 m, 20 m, 30 m, 40 m and 50 m. The germination results were observed at room temperature to determine the extent of the aura (see Table 42).

(1) The seeds were placed in a dark place for 5 days and the germination rate was observed 5 times.

(2) The statistical values are based on the total (100%) of 5 measurements.

TABLE 42
Comparison of the germination of seeds by
jade porcelain (number of germinated seeds)

| | Jade | | | | | | | | | | | |
|---|---|---|---|---|---|---|---|---|---|---|---|---|
| Name | porcelain | | 10 m | | 20 m | | 30 m | | 40 m | | 50 m | |
| of seed | 3 | 5 | 3 | 5 | 3 | 5 | 3 | 5 | 3 | 5 | 3 | 5 |
| Rice | 51 | 90 | 45 | 85 | 46 | 91 | 49 | 92 | 40 | 92 | 41 | 88 |
| Radish | 90 | 96 | 88 | 95 | 88 | 94 | 89 | 95 | 81 | 94 | 82 | 95 |
| Crown | 54 | 70 | 51 | 58 | 50 | 71 | 49 | 69 | 45 | 69 | 46 | 70 |
| daisy | | | | | | | | | | | | |
| Pea | 25 | 60 | 24 | 61 | 24 | 58 | 23 | 60 | 20 | 59 | 19 | 58 |
| Chinese | 74 | 93 | 72 | 95 | 74 | 96 | 71 | 94 | 69 | 94 | 68 | 93 |
| cabbage | | | | | | | | | | | | |

The results suggest that the aura of jade water was exerted over approximately 30 m and promoted the germination of the seeds.

### Experimental Example 21

Effects of Jade Porcelain and Jade Water on the Growth Rate of Bean Sprouts

To examine the effects of jade porcelain and supernatant jade water on the growth of plants, rooting experiments of bean sprouts and onion were carried out.

(1) 30 beans for bean sprouts were placed in each vessel for cultivating bean spouts, and then the germination rates and growth rates were observed at room temperature for 10 days, with each of jade water, underground water and tap water being supplied to the vessel.

(2) 30 beans were placed in each of jade porcelain, plain porcelain and a plastic vessel, and then the germination rates and growth rates were observed at room temperature for 10 days.

(3) 3 onions of the same size were subjected to rooting experiments, with each of jade water, underground water and tap water being supplied.

(4) Jade porcelain and jade water were spaced 50 m apart from the other vessels containing no jade material.

The experimental results are described below.

1) Growth of Bean Sprouts by Jade Porcelain

Since the aura of jade porcelain promoted the germination of seeds, it was confirmed that the aura of jade porcelain had the effects on the growth rate of bean sprouts.

2) Growth of bean sprouts by jade water

Since the aura of jade water promoted the germination of beans, it was confirmed that the aura of jade water had the effects on the growth of bean sprouts.

### Experimental Example 22

Comparison of the freshness of plants by jade porcelain and jade water

(1) Flowers of the same kind were put into jade porcelain and plain porcelain, and their freshness was observed while supplying underground water.

(2) Flowers of the same kind were put into glass cups, and their freshness was observed while supplying each of jade water, underground water and tap water.

(3) The jade porcelain and jade water were spaced 50 m apart from vessels containing no jade material.

(4) The flowers used were each 5 roses, carnations and chrysanthemum plucked at the same period of time, and flowers of the same blooming extent were selected and observed visually once a day.

The results are described below.

1) Jade Porcelain and Freshness of Plants

The aura of jade porcelain was concluded to slightly affect the freshness of plants.

2) Jade Water and Freshness of Plants

The aura of jade water was adjudged to slightly affect the freshness of plants.

### Experimental Example 23

Effect of nephrite jade powder on the growth of plants

(1) 3 seeds of each of haricot bean, pea, radish and cabbage were sowed in each of a pot containing 50 g of nephrite jade powder and a port containing 50 g of fine sand, and the growth rates of the plants were observed.

(2) Due to difficulty in fertilization, radish and cabbage were not fertilized. However, seeds of haricot bean and pea were sowed with leaf mold and sand mixed in the same ratio.

(3) The nephrite jade powder port and the plain pot were spaced 50 m apart from each other.

The results are described below.

1) Growth of Pea

Since the aura of nephrite jade powder promoted the germination of seeds, it is considered to slightly affect the growth of pea.

2) Growth of Haricot Bean (m)

Since the aura of nephrite jade powder promoted the germination of haricot bean, it is considered to slightly affect the growth of haricot bean.

3) Aquiculture of Onion

The aura of jade water was considered to considerably affect the rooting of onion.

4) Growth Rate of Radish

The nephrite jade powder is considered to affect the sprouting timing of radish to promote the growth of radish.

As can be confirmed from the above-described experimental examples, the following conclusions are suggested.

(1) The Chuncheon nephrite jade has a negative values of δ ¹⁸O and a hardness of 6-6.5, and the measured values of δ D of the nephrite jade are determined by a hydroxyl group, the value of δ ¹⁸D of the hydroxy group being considerably lower than that of the overall mineral and being out of the range of degenerated water (δ D (%)=0 to −70).

(2) The components of nephrite jade samples are different depending on the collection place.

(3) The aura generated from nephrite jade and jade porcelain has effects on the germination and growth of plants reaches within a range of about 30 m.

(4) The aura of jade water has effects on the germination and growth of plants within a range of 20-30 m and is slightly weaker than the aura of nephrite jade.

(5) The germination experiments showed that both jade water and jade porcelain promoted the germination of seeds, although there was a slight difference between the control group and the treated group.

(6) The growth of radish, pea, haricot bean and cabbage were promoted by nephrite jade powder. This suggests that acidified water can be improved by a new fertilization method using nephrite jade or jade water to be used for aquiculture. Also, the nephrite jade or jade water can be used as a neutralizer of drinking water, an agent for removing concentrated heavy metals or an agent for promoting the growth of plants

### Experimental Example 24

This experiment was performed to examine the effects of the inventive jade products (jade tile, jade disk, jade powder, jade padding or the like) on the survival and propagation of marine microorganisms.

(1) Microorganism Source

In this experiment, sea water available from Daecheon, South Korea, which is mainly used for manufacturing media, was used as the source of marine bacteria. The aged sea water was used in the state in which most organic materials were decomposed by preserving the sea water in a dark place for 6 months. The marine photobacterium phosphoreum used in the experiment is a Gram-negative bacterium, and the sample thereof was used to exhibit a luminescence intensity of 1.4×1014 quanta/sec per milliliter. The sample was diluted and about 1% of the diluted sample was taken for inoculation. Then, in order to examine the changes in the growth of cells and the luminescence intensity with time, the adsorption at 660 nm and the luminescence intensity of 1 ml sample were measured using a spectrophotometer (Milton-Roy MR 3000) and a luminometer, respectively.

(2) Media Used

Media used in this experiment were Zobell medium that has been traditionally used for cultivating marine bacteria, and a sea water complete medium, and the compositions thereof are as follows:

<Zobell Medium>

3 g Bactotryptone; 1 g Yeast extract; 0.1 g FeCl3; 700 ml aged sea water; and 300 ml distilled water.

<Sea Water Complete Medium>

5 g Bactotryptone; 3 g Yeast extract; 3 ml Glycerol; 750 ml aged sea water; and 250 ml distilled water.

3M Petri-Film

The petri-film as the medium used for colony forming unit (CFU) was commercially available from 3M Company. 1 ml of a target sample was applied to the film, pressed and cultivated for 3 days. Then, the number of red colonies was counted and the colony was photographed by a digital camera (Kodak DC-120).

The jade tile, jade disk, jade powder, jade ore, jade padding or the like used in the experiments were produced from nephrite jade available from Chuncheon, South Korea (produced by Ocksanga Co., Ltd., South Korea). Each experimental group was placed and cultured in a 100-ml culture flask. The jade powder was used in an amount of 1 g per 100 ml of sea water, and the jade ore used was also cut into pieces of 1 g. Also, the jade padding used was 1 g in total weight.

(3) Experimental Contents

A. Change in pH

100 ml of sea water was used as a control group, and 1 g of jade powder was added thereto. Then, the mixture was stirred with a magnetic stirrer for 30 minutes, and centrifuged to obtain the supernatant. Then, the pH change of the supernatant according to the concentration of jade powder was measured.

B. Change in the number of colonies General sea water was used after dilution with sterile sea water.

<Solid Medium>

Petrifilm

ZoBell plate

<Liquid Medium>

Cultured on jade tile

Cultured on jade disk

Cultured with jade ore

C. Change in Luminescence Intensity

The sample of photobacterium phosphoreum was cultured in a sea water complete medium to a luminescence intensity of about 1.4×10¹⁴ quanta/sec per milliliter. The sample was diluted and about 1% of the diluted sample was inoculated. Then, to examine the changes in the growth of cells and the luminescence intensity with time, the adsorption at 660 nm and the luminescence intensity of 1 ml sample were measured using a spectrophotometer (Milton-Roy MR 3000) and a luminometer, respectively.

(4) Measurement of Biomass

Measurement of Biomass Using Firefly Luciferase Illumination System

There are various methods of measuring biomass. However, a method of measuring the quantity of ATPS (adeonosine-5-triphosphates), the ATP being a bioindicator since it is commonly contained in all living things, has been used for measurement of the biomass of an invisible microorganism. ATPS are essential factors for maintaining the lives of organisms higher than bacteria and are generated by the metabolism of various kinds of organisms to be used as a direct fuel in cells. Since the ATP is rapidly decomposed into ADP (adenosine-5-diphosphate) in dead organisms, it can be a good indicator for measurement of the biomass of a living organism. On the other hand, if the biomass is estimated by the naked eye or microscope, it is quite difficult to distinguish live and dead organisms. In the case of microorganisms, a cultivation method cannot be used for measurement of the biomass of a viable but non-cultural (VBNC) cell. Also, less than 1% of marine organisms can only be cultivated by a general cultivation method.

Since the extinction rate of living organisms on the surface of jade products is very important in the samples used in the experiment of the invention, it is very important to accurately measure the biomass. ATP measurement was done by extracting a sediment by means of a buffer. Here, various chromatographic methods including High Performance Liquid Chromatography (HPLC) or Thin Layer Chromatography (TLC) can be used. In this study, a bioluminescence method for the firefly that generates light using ATP was employed. Although the HPLC or TLC method allows accuracy in the measurement result, pretreatment of samples is very complex, requiring much time and effort, and the detection accuracy thereof is low due to use of UV adsorption or pigmenting dependence. A firefly luciferase generates light of 530 nm while converting luciferin into oxyluciferin using 1M of ATP and 1M of oxygen, and the luminescence efficiency is substantially 100%, highest among known bioluminescence systems. Measurement of the quantity of ATO using the firefly luciferase is recognized as the most sensitive method, excluding the method using radioactive isotropes.

(5) Experimental Results

5.1 Change in pH

Sea water generally exhibits a weak alkaline pH, i.e., a pH of about 8.1, which becomes gradually neutral by the metabolic activity of microorganisms contained in the sea water when it is left intact for a long time. This is well defined by the control group of Table 21. In the presence of jade products, a slight change in pH occurred immediately (i.e., within 1 hr) after addition thereof. Both jade powder and jade ore showed a change of pH of approximately 7.8, that is, a weak alkaline level. This tendency is mitigated in the case of jade tile that is not in direct contact with the sea water solution, that is, substantially similar to that of the control group. The results suggest that materials eluted from the jade product itself to ambient solution, representatively silica (SiO₂), changed the acidity.

TABLE 43
Change in pH of sea water by jade products

| | 1 hr | 2 hrs | 3 hrs |
|---|---|---|---|
| Control group | 8.18 | 8.16 | 8.15 |
| Jade powder | 8.01 | 7.75 | 7.55 |
| Jade padding | 8.10 | 7.80 | 7.64 |
| Jade tile | 8.12 | 8.05 | 7.95 |
| Jade disk | 8.1 | 8.0 | 7.8 |
| Jade ore | 8.1 | 8.0 | 7.8 |

5.2. Change in Number of Colonies

100 ml of standard sea water was placed in a sterilized bottle, and various jade products were added thereto in each given amount. The content of the bottle was cultured with stirring at about 100 rpm, and 1 ml of the content of the bottle was taken at each time point and inoculated using a petri-film. The number of colonies produced after 3 days of culture was counted (see Table 44).

TABLE 44
Change in number of colonies by jade products

| | After 1 | After 2 | After 3 | After 7 |
|---|---|---|---|---|
| | day | days | days | days |
| Control group | 324 | 336 | 328 | 319 |
| Jade powder | 284 | 272 | 243 | 217 |
| Jade padding | 274 | 265 | 232 | 204 |
| Jade tile | 283 | 274 | 281 | 295 |
| Jade disk | 272 | 261 | 255 | 275 |
| Jade ore | 269 | 261 | 253 | 282 |

As can be seen from the results of Table 44, all jade products showed a noticeable decrease in the number of marine bacteria. During an early stage, jade padding and jade ore showed a high decrease rate. After 7 days of culture, jade powder and jade padding showed the highest decrease rate. Jade padding, in particular, had the highest decreasing effect, approximately 64% of that of the control group, after 7 days.

3. Change in Luminescence Intensity

With respect to the change in luminescence intensity of photobacterium phosphoreum, there was no considerable change in luminescence intensity by jade products used in the experiment. Although the change was as weak as 10% or less, a decreasing tendency was shown in all the samples. This suggests that jade products serve to suppress the activity of marine bacteria, as shown in the above-described experiments. The photobacterium phosphoreum is a typical adhering bacterium that easily adheres to organic mass present in the sea water and propagates to exhibit luminescence, which increases the possibility of penetrating into the interior of fish together with fish-bait (see Table 45)

TABLE 45
Change in luminescence intensity of photobacterium phosphoreum
by jade products

| | 1 hr | 2 hrs | 24 hrs |
|---|---|---|---|
| Control group | 100 | 100 | 100 |
| Jade powder | 94 | 93 | 88 |
| Jade padding | 92 | 90 | 85 |
| Jade tile | 95 | 92 | 84 |
| Jade disk | 95 | 90 | 82 |
| Jade ore | 93 | 90 | 82 |

5.4. Degree of Adhesion to Surface

It is known that bacteria in the sea water primarily adhere to the surface of matter immersed in the sea water to form a bio-film, and other marine organisms sequentially adhere by the action of the bio-film as a basal material, thus causing bio-fouling.

Although the reason why the jade products have antimicrobial functions is unclear, the antibacterial functions have been confirmed through the above-described experimental examples. Thus, the jade products used in the present experiment can be used as valuable materials, if they serve to suppress the formation of a bio-film.

The experimental results showed that the adhesion of bacterial to the jade products was 92-95% of that of the control group, suggesting an adhesion reducing effect of 5-8% (see Table 46).

TABLE 46
Degree of adhesion of photobacterium phosphoreum
to the surface of jade products (1-week culture)

| | Number of bacteria adhered (%) | Count × 10⁵ |
|---|---|---|
| Control group | 100 | 3.2 |
| Jade tile | 95 | 3.04 |
| Jade disk | 93 | 2.97 |
| Jade ore | 92 | 2.94 |

(4) Results

As can be seen from the above-described experimental examples, the use of nephrite jade of the present invention reduced general bacteria from sea water by 10-40%, suggesting that the use of nephrite jade is worth trying in a pilot-sized cultivation tank. In particular, since jade tile can be used as the material of the bottom of a cultivation tank, the experiment of the initial survival rate of fry can be performed in a water tank having a size of at least 2 m (width)×3 m (length)×1 m (depth).

### Experimental Example 25

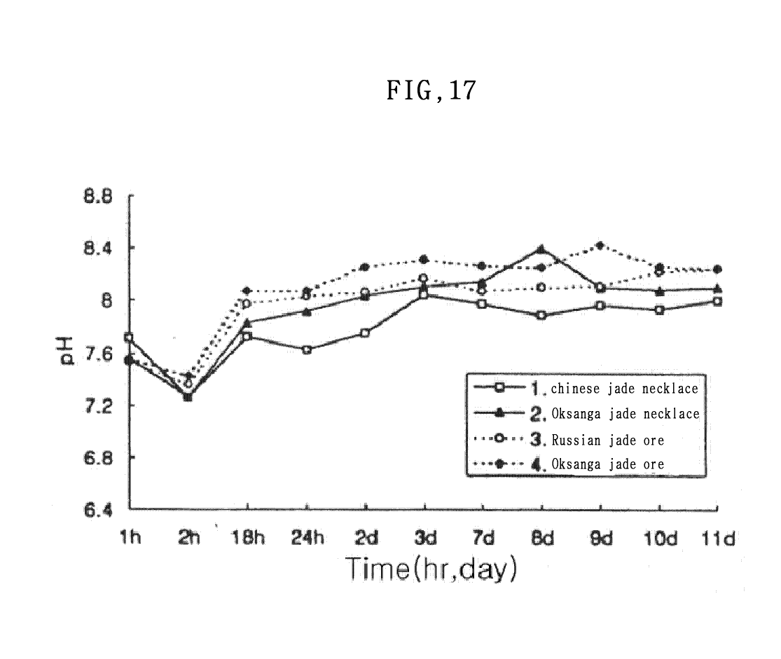

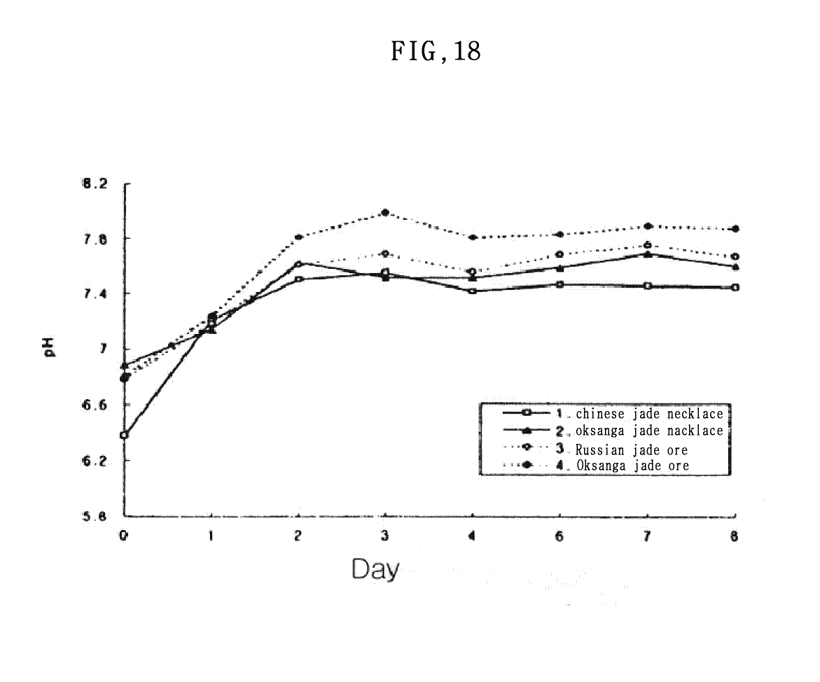

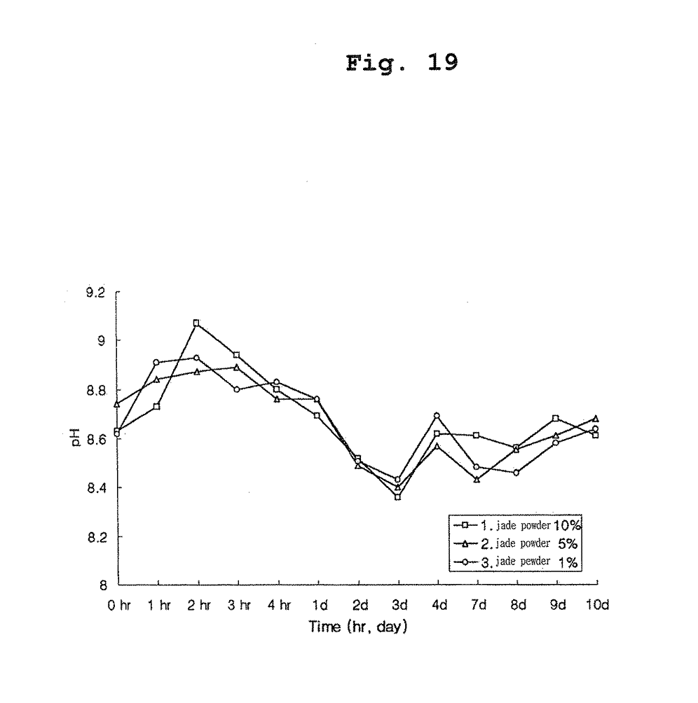

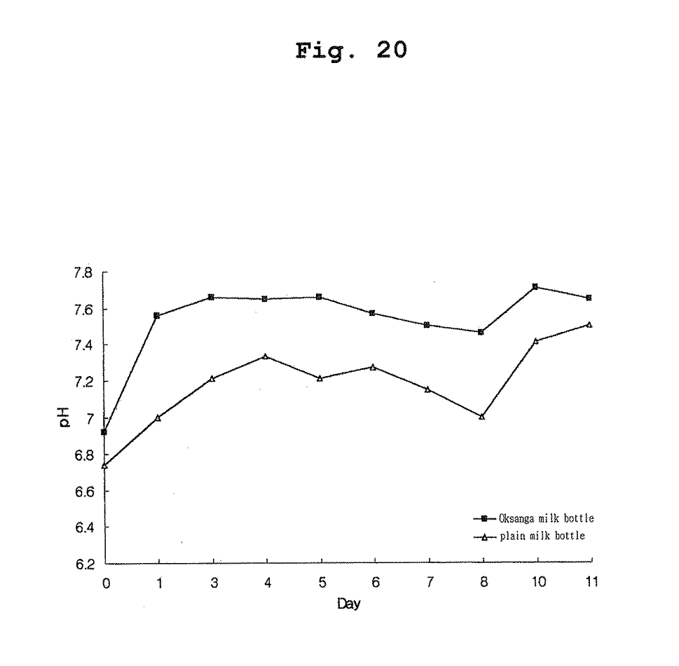

This experiment was performed to examine the change in pH with time when jade ore, jade necklace and jade powder were immersed into or added to water supplied from various sources for 8 to 11 days (FIGS. 17 to 20).

The jade materials used in the experiment were jade ores available from Chuncheon, South Korea (Ocksanga Co., Ltd.) and Russia, jade necklaces produced from nephrite jade available from Chuncheon, South Korea and China, and jade powder produced from nephrite jade available from Chuncheon, South Korea. Water used for measurement of pH was water from a general purifier, underground water, and strong acidic solution (pH 3.2).

### <Results>

(1) When jade ore and jade necklace were immersed into the water from a general purifier and underground water, the pH levels of the jade ore and necklace produced from the nephrite jade available from Chuncheon, South Korea, were higher than those made from nephrite jade in China and Russia.

(2) Jade powder were added to a strong acidic solution of pH 3.2 in amounts of 10%, 5% and 1%, and the average pH levels measured for 10 days were 8.59±0.10, 8.58±0.13 and 8.57±0.11, respectively, suggesting there is little difference between the average pH levels according to the amounts of jade powder added.

(3) During the measurement period, the pH levels of the strong acidic solution in the jade-treated milk bottle were consistently higher than in a plain milk bottle.

As can be seen from the above results, the jade ore, jade powder and jade necklace made from the nephrite jade collected from Chuncheon, South Korea increased the pH of water compared to those produced from nephrite jade collected from Russia and China, but there was no statistically significant difference.

The above-described experimental results fully verify that the use of the matrix containing nephrite jade powder of the present invention provides beneficial effects to the human body in virtue of the inherent properties of nephrite jade powder together with the effects of bentonite or zeolite.

As described above, the matrix of the present invention contains nephrite jade powder and bentonite or zeolite, which are beneficial to the human body. Thus, the matrix of the present invention can be used in various products, including various utensil goods, medical goods, interior and exterior materials for construction, and food containers.

Although the present invention has been described in detail with reference to the specific features, it will be apparent to those skilled in the art that this description is only for a preferred embodiment and does not limit the scope of the present invention. Thus, the substantial scope of the present invention will be defined by the appended claims and equivalents thereof.

What is claimed is:

1. A matrix containing nephrite jade powder as a main component, wherein the matrix comprises, based on the total weight of a synthetic resin raw material, 1-4.5 wt % of nephrite powder having a particle size of 360-1,000 mesh, and 0.5-1 wt % of bentonite.

2. The matrix of claim 1, wherein the nephrite jade a tremolite nephrite jade in dolomitic marble, which has a negative value of δ ¹⁸0.

3. A matrix containing nephrite jade powder as a main component, wherein the matrix comprises, based on the total weight of a synthetic resin raw material, 1-4.5 wt % of nephrite powder having a particle size of 360-1,000 mesh, and 0.5-1 wt % of zeolite.

4. The matrix of claim 3, wherein the nephrite jade a tremolite nephrite jade in dolomitic marble, which has a negative value of δ ¹⁸0.

5. A matrix containing nephrite powder as a main component, the method comprising the steps of:
adding to a synthetic resin raw material 1-4.5 wt % of nephrite powder having a particle size of 360-1,000 meshes and 0.5-1 wt % of bentonite or zeolite to obtain a mixture;
heating the mixture at a temperature between 135° C. and 145° C.; and
molding the heated mixture to obtain a compound.

6. The matrix of claim 5, wherein the nephrite jade a tremolite nephrite jade in dolomitic marble, which has a negative value of δ ¹⁸0.
